(19) United States
(12) Patent Application Publication
(10) Pub. No.: US 2017/0094014 A1
(43) Pub. Date: Mar. 30, 2017

(54) CONTROL METHOD, CONTROL DEVICE, AND RECORDING MEDIUM

(71) Applicant: Panasonic Intellectual Property Management Co., Ltd., Osaka (JP)

(72) Inventors: KUNIO NAKATSUKASA, Kyoto (JP); TOMONORI NAKAMURA, Osaka (JP); HIROO ISHIKAWA, Kanagawa (JP); SHIKI KOU, Osaka (JP)

(21) Appl. No.: 15/267,158

(22) Filed: Sep. 16, 2016

(30) Foreign Application Priority Data
Sep. 24, 2015 (JP) 2015-186703

(51) Int. Cl. H04L 29/08

(52) U.S. Cl. CPC H04L 67/32; H04L 67/143; H04L 67/141

(57) ABSTRACT

A control method for a controller connected to a first appliance includes: accepting a first request for causing the first appliance to execute a first service, the first appliance being disposed in a first space; transmitting a first command to execute the first service to the first appliance; acquiring first information indicative of an environment state of the first space; and determining whether or not the environment state satisfies a termination condition of the first service based on a correspondence between the first service and the termination condition and the first information, when it is determined that the environment state does not satisfy the termination condition, a second request for causing the first appliance to execute a second service different from the first service is not accepted, and a second command to execute the second service is not transmitted to the first appliance.

### BACKGROUND

1. Technical Field

The present disclosure relates to a reconciliation method, a reconciliation device, and a recording medium storing a reconciliation program that reconcile a plurality of control requests transmitted to cause an appliance to execute a plurality of respective different services.

2. Description of the Related Art

A technique for remotely controlling a household electrical appliance or the like over a network by using an application installed in a controller is conventionally known. The application executes a service of controlling the appliance on the basis of a user's operation using input means such as a GUI (Graphical User Interface) or speech interaction and a service of automatically controlling the appliance on the basis of a specific rule (e.g., turning on an illumination appliance when a door opens). In a case where such various services are executed, a plurality of control requests that compete against each other are sometimes issued so as to cause a single appliance to execute different services. The expression “control requests compete against each other” as used herein means that a single appliance is controlled by one or a plurality of terminal devices concurrently or in a short period. Occurrence of competition has a risk of failure to properly execute the services and confusion of a user.

Such a problem can be solved by executing only a control request corresponding any one of the services upon occurrence of competition between the control requests. For example, Japanese Unexamined Patent Application Publication No. 2013-2680 describes a technique for forcibly switching general control to energy-saving control after elapse of a predetermined period from switching from energy-saving control to general control.

Furthermore, for example, Japanese Unexamined Patent Application Publication No. 2014-202418 discloses a technique for determining whether or not to execute an operation command for an appliance. In Japanese Unexamined Patent Application Publication No. 2014-202418, whether or not to execute an operation command is determined in accordance with an operating state of an appliance to be controlled and contents of the operation command while the appliance is being remotely controlled from an outside of a house.

However, the conventional control devices need further improvements because the conventional control devices fail to determine whether or not a service is executable in accordance with contents of appliance control and a change of an environment in a space in which the appliance is placed.

### SUMMARY

In one general aspect, the techniques disclosed here feature a control method in a controller connected to a first appliance, including: accepting a first request for causing the first appliance to execute a first service, the first appliance being placed in a first space; transmitting a first command to execute the first service to the first appliance; acquiring first information indicative of an environment state of the first space; and determining whether or not the environment state satisfies a termination condition of the first service on basis of a correspondence between the first service and the termination condition of the first service and the first information, in a case where it is determined that the environment state does not satisfy the termination condition of the first service, a second request for causing the first appliance to execute a second service different from the first service not being accepted, and a second command to execute the second service not being transmitted to the first appliance.

According to the present disclosure, it is possible to set a period in which a first service occupies a first appliance in accordance with an environment in a space that changes by execution of the first service and to reconcile a first control request and a second control request that compete against each other.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram schematically illustrating a configuration of an appliance control system according to Embodiment 1 of the present disclosure;

FIG. 2 is a diagram illustrating an example of a hardware configuration of a reconciliation device according to Embodiment 1 of the present disclosure;

FIG. 3 is a diagram illustrating an example of a detailed configuration of the reconciliation device according to Embodiment 1 of the present disclosure;

FIG. 4 is a diagram illustrating an example of a reconciliation management table according to Embodiment 1 of the present disclosure;

FIG. 5 is a diagram illustrating another example of the reconciliation management table according to Embodiment 1 of the present disclosure;

FIG. 6 is a diagram illustrating an example of a state monitoring table according to Embodiment 1 of the present disclosure;

FIG. 7 is a flow chart for explaining an example of a procedure for executing a service by the reconciliation device;

FIG. 8 is a diagram illustrating an example of a configuration of a manifest that defines attributes of a service;

FIG. 9 is a diagram illustrating an example of a termination condition in the manifest;

FIG. 10 is a diagram illustrating an example of a configuration of a manifest having no termination condition;

FIG. 11 is a first flow chart for explaining a flow of processes of the reconciliation device performed in a case where an appliance executes a service;

FIG. 12 is a second flow chart for explaining a flow of processes of the reconciliation device performed in a case where an appliance executes a service;

FIG. 13 is a flow chart for explaining an interruption determining process in Step S12 of FIG. 11;

FIG. 14 is a flow chart for explaining a competition determining process in Step S18 of FIG. 12;

FIG. 15 is a flow chart for explaining a dependency setting process in Step S20 of FIG. 12;

FIG. 16 is a flow chart for explaining a state monitoring table updating process in Step S21 of FIG. 12;

FIG. 17 is a diagram illustrating an example of a correspondence table in which appliance IDs and appliance types are associated with each other according to Embodiment 1 of the present disclosure;

FIG. 18 is a flow chart for explaining a monitored target setting process in Step S64 of FIG. 16;

FIG. 19 is a flow chart for explaining a service monitoring process performed in a state monitoring unit;

FIG. 20 is a flow chart for explaining a service monitoring process performed in an execution determining unit;

FIG. 21 is a flow chart for explaining a target value determining process in Step S92 of FIG. 19;

FIG. 22 is a diagram illustrating an example of a notification screen for user's confirmation as to whether or not to terminate appliance control;

FIG. 23 is a diagram illustrating an example of a notification screen for user's confirmation as to whether or not switch appliance control;

FIG. 24 is a diagram illustrating an example of a termination condition in a manifest according to Embodiment 2 of the present disclosure;

FIG. 25 is a diagram illustrating an example of a state monitoring table according to Embodiment 2 of the present disclosure;

FIG. 26 is a diagram illustrating an example of a correspondence table in which appliance IDs, appliance types, and installation places are associated with one another according to Embodiment 2 of the present disclosure;

FIG. 27 is a flow chart for explaining a state monitoring table updating process according to Embodiment 2 of the present disclosure;

FIG. 28 is a flow chart for explaining a monitored property value acquiring process in Step S129 of FIG. 27;

FIG. 29 is a flow chart for explaining a target value determining process according to Embodiment 2 of the present disclosure;

FIG. 30 is a diagram illustrating an example of a detailed configuration of a reconciliation device according to Embodiment 3 of the present disclosure; and

FIG. 31 is a flow chart for explaining an operation of a reconciliation process performed by a first reconciliation device and a second reconciliation device according to Embodiment 3 of the present disclosure.

### DETAILED DESCRIPTION

### Underlying Knowledge Forming Basis of the Present Disclosure

In recent years, a service of remotely controlling a household electrical appliance connected to a network and a service of causing a plurality of household electrical appliances to operate in cooperation with one another have been considered. If the number of services increases, there is a possibility that a user is confused because the services are not properly executed due to competition among controls. Such a problem can be solved, for example, by giving priorities to respective services in advance, regarding that a service with a high priority occupies an appliance, and executing only the service with a high priority upon occurrence of competition. However, it is unclear how long the appliance should be occupied by the service with a high priority.

For example, in a case where a service of turning on an illumination appliance at night is executed, it is natural to consider it appropriate to maintain an ON state of the illumination appliance, that is, to continue occupation of the illumination appliance by the service during a period from dusk to bedtime of a user or during a period from dusk to dawn. Meanwhile, in a case where a service of lowering a set temperature of an air conditioner by using a remote control is executed, it is natural to consider it appropriate to maintain the temperature setting service until a room temperature is sufficiently lowered or a body temperature of a person who operates the remote control is sufficiently lowered. This indicates that a period of occupation of an appliance by a service depends on a purpose of appliance control, a change of an environment in a space caused by appliance control, and the like.

In Japanese Unexamined Patent Application Publication No. 2013-2680, a succeeding service occupies an appliance for a predetermined period after the succeeding service is executed, but an appliance cannot be controlled in accordance with a purpose of appliance control or a change of an environment in a space.

In Japanese Unexamined Patent Application Publication No. 2014-202418, it is determined whether or not an operation command (succeeding service) is executed in accordance with an operating state of a controlled appliance and contents of the operation command, but the operation command is limited to control of turning on an air conditioner from a remote place and is hard to be applied to various services.

In view of this, the inventor considered the following improvements.

(1) A control method according to one aspect of the present disclosure is a control method for a controller connected to a first appliance includes: accepting a first request for causing the first appliance to execute a first service, the first appliance being disposed in a first space; transmitting a first command to execute the first service to the first appliance; acquiring first information indicative of an environment state of the first space; and determining whether or not the environment state satisfies a termination condition of the first service based on a correspondence between the first service and the termination condition of the first service and the first information, when it is determined that the environment state does not satisfy the termination condition of the first service, a second request for causing the first appliance to execute a second service different from the first service is not accepted, and a second command to execute the second service is not transmitted to the first appliance.

According to the arrangement, a first control request for executing a first service among a plurality of services is accepted, and control of a first appliance based on the first control request is permitted. Space estimation information for estimating a state of a space relevant with continuation or termination of the first service is acquired. It is determined whether or not the state of the space estimated on the basis of the space estimation information is a state that should be satisfied by the first service. In a case where it is determined that the state of the space is not a state that should be satisfied by the first service, a second control request for causing the first appliance to execute a second service different from the first service is not accepted.

This makes it possible to set a period in which the first service occupies the first appliance in accordance with an environment in a space that changes by execution of the first service and to reconcile the first control request and the second control request that compete against each other.

(2) In the aspect, the control method may be arranged such that the first information includes a temperature value, a humidity value, or an illuminance value of the first space.

This makes it possible to set a period in which the first service occupies the first appliance in accordance with temperature, humidity, or illuminance in the space.

(3) In the aspect, the control method may be arranged such that when it is determined that the environment state satisfies the termination condition of the first service, the second request is accepted, and the second command to execute the second service is transmitted to the first appliance.

According to the arrangement, when it is determined that the state of the space is a state that should be satisfied by the first service, the second control request is accepted. Then, control of the first appliance based on the second control request is permitted. This makes it possible to switch the first service to the second service.

(4) In the aspect, the control method may be arranged such that the first appliance is disposed at a first position in the first space, the first information indicates the environment state at the first position, and the first information is acquired from the first appliance.

This makes it possible to set a period in which the first service occupies the first appliance in accordance with a state of the first appliance that executes the first service.

(5) In the aspect, the control method may be arranged such that the controller is further connected to a second appliance different from the first appliance; the second appliance is disposed at a second position in the first space, the first information indicates the environment state at the second position, and the first information is acquired from the second appliance.

This makes it possible to set a period in which the first service occupies the first appliance in accordance with a state of the second appliance different from the first appliance that executes the first service.

(6) In the aspect, the control method may be arranged such that the first information include a parameter that is the same as a parameter changed when the first appliance executes the first service.

This makes it possible to set a period in which the first service occupies the first appliance in accordance with a change of a state indicated by a controlled target item for controlling the first appliance that executes the first service.

(7) In the aspect, the control method may be arranged such that the first information include a parameter that is different from a parameter changed when the first appliance executes the first service.

This makes it possible to set a period in which the first service occupies the first appliance in accordance with a change of a state different from the state indicated by a controlled target item for controlling the first appliance that executes the first service.

(8) In the aspect, the control method may be arranged such that the first information includes a numeric value corresponding to the environment state, and it is determined that the environment state does not satisfy the termination condition of the first service when the numeric value is not within a predetermined range.

This makes it possible to easily designate a period in which the first service occupies the first appliance by determining whether or not a numeric value indicative of a current state of the space is within a range of a target value.

(9) In the aspect, the control method may be arranged such that the first information includes a numeric value indicative of an amount of change of the environment state from transmission of the first command to the first appliance to a current time, and it is determined that the environment state does not satisfy the termination condition of the first service when the amount of change is not within a predetermined range.

This makes it possible to easily designate a period in which the first service occupies the first appliance by determining whether or not a numeric value indicative of an amount of change of the state of the space from the start of control of the first appliance to a current time is within a range of a target value.

(10) In the aspect, the control method may be arranged such that the controller is further connected to a second appliance different from the first appliance; the first appliance is disposed at a first position in the first space, the second appliance is disposed at a second position in the first space, the first information includes second information indicative of a first environment state at the first position and third information indicative of a second environment state at the second position, the second information is acquired from the first appliance; the third information is acquired from the second appliance, and it is determined that the environment state does not satisfy the termination condition of the first service when the first environment state and the second environment state do not satisfy a predetermined condition.

This makes it possible to set a period in which the first service occupies the first appliance in accordance with all of states of a plurality of appliances.

(11) In the aspect, the control method may be arranged such that the controller is further connected to a second appliance different from the first appliance; the first appliance is disposed at a first position in the first space, the second appliance is disposed at a second position in the first space, the first information includes second information indicative of a first environment state at the first position and third information indicative of a second environment state at the second position, the second information is acquired from the first appliance; the third information is acquired from the second appliance, and it is determined that the environment state does not satisfy the termination condition of the first service when at least one of the first environment state and the second environment state does not satisfy a predetermined condition.

This makes it possible to set a period in which the first service occupies the first appliance in accordance with at least one of states of a plurality of appliances.

(12) In the aspect, the control method may be arranged such that the controller is further connected to a second appliance different from the first appliance, the first appliance is disposed at a first position in the first space, the second appliance is disposed at a second position in the first space, the first information includes second information indicative of a first environment state at the first position and third information indicative of a second environment state at the second position, the second information is acquired from the first appliance, the third information is acquired from the second appliance, the first environment state is a first value, the second environment state is a second value, and it is determined that the environment state does not satisfy the termination condition of the first service when an average of the first value and the second value does not satisfy a predetermined condition.

This makes it possible to set a period in which the first service occupies the first appliance in accordance with an average of numeric values indicative of states of a plurality of appliances.

(13) In the aspect, the control method may be arranged such that the first space is a closed space.

This makes it possible to set a period in which the first service occupies the first appliance in accordance with an environment in a space in which a plurality of appliances are present.

(14) In the aspect, the control method may be arranged such that the first information indicates an elapsed period from transmission of the first command to a current time, and it is determined that the environment state does not satisfy the termination condition of the first service when the elapsed period is not within a predetermined range.

This makes it possible to determine a period in which the first service occupies the first appliance in accordance with an elapsed period from the start of control of the first appliance to a current time.

(15) In the aspect, the control method may be arranged such that the first information indicates an elapsed period from a timing at which the first appliance reaches a predetermined state after transmission of the first command to a current time, and it is determined that the environment state does not satisfy the termination condition of the first service when the elapsed period is not within a predetermined range.

This makes it possible to determine a period in which the first service occupies the first appliance in accordance with an elapsed period from a timing at which the state of the first appliance reaches a predetermined state after the start of control to a current time.

(16) In the aspect, the control method may be arranged such that the controller includes a memory, and the correspondence is stored in the memory.

This allows a service provider to set a period in which the first service occupies the first appliance since it is determined whether or not the state of the space estimated on the basis of the space estimation information is a state that should be satisfied by the first service by using condition definition information included in service definition information.

(17) In the aspect, the control method may be arranged such that the correspondence is included in the first request.

This makes it possible to set, every time execution of the first service starts, a period in which the first service occupies the first appliance since it is determined whether or not the state of the space estimated on the basis of the space estimation information is a state that should be satisfied by the first service by using condition definition information acquired from the first control request.

(18) In the aspect, the control method may be arranged such that the correspondence is input to the controller by a user of the first appliance.

This makes it possible to set a period in which the first service occupies the first appliance in accordance with user's preference since it is determined whether or not the state of the space estimated on the basis of the space estimation information is a state that should be satisfied by the first service by using condition definition information input by the user.

The present disclosure can be realized not only as a control method that executes the aforementioned characteristic processes, but also as a control device or the like that includes a processing unit for executing characteristic steps included in the control method. Furthermore, the present disclosure can also be realized as a computer program for causing a computer to execute the characteristic steps included in the control method. Such a computer program can be distributed via a non-transitory computer-readable recording medium such as a CD-ROM or a communication network such as the Internet.

Each of the embodiments described below is a specific example of the present disclosure. Numeric values, shapes, materials, constituent elements, steps, the order of steps, and the like in the embodiments below are examples and do not limit the present disclosure. Among constituent elements in the embodiments described below, constituent elements that are not described in independent claims that indicate the highest concepts are described as optional constituent elements. Furthermore, contents of all of the embodiments may be combined.

### Embodiment 1

First, an overall configuration of appliance control according to an embodiment of the present disclosure is described.

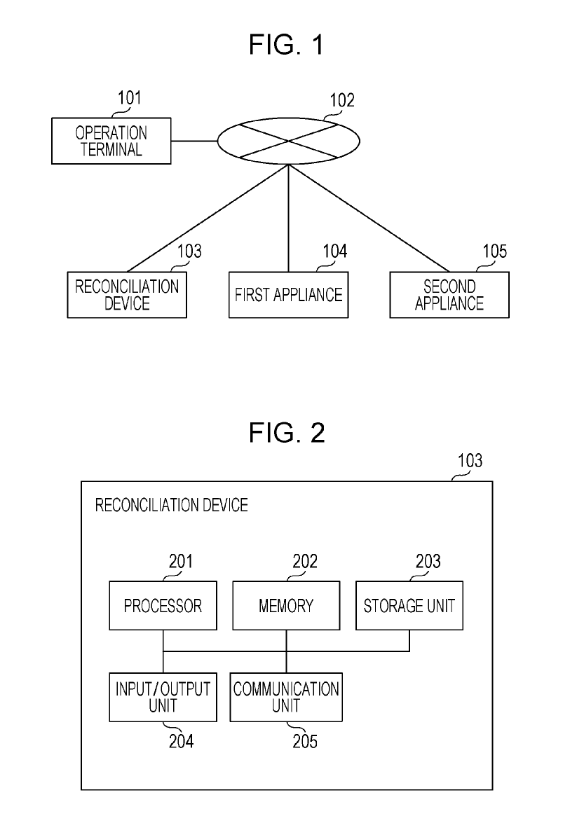

FIG. 1 is a diagram schematically illustrating a configuration of an appliance control system according to Embodiment 1 of the present disclosure.

The appliance control system illustrated in FIG. 1 includes an operation terminal 101, a reconciliation device 103, a first appliance 104, and a second appliance 105.

The first appliance 104 and the second appliance 105 are, for example, household electronic appliances such as an air conditioner, an illumination appliance, a refrigerator, a microwave oven, a cooking heater, an electric lock, an electric shutter, a human sensor, a temperature sensor, a humidity sensor, or an air chamber sensor.

The operation terminal 101 accepts a user's operation and transmits, to the reconciliation device 103, a control request for causing the first appliance 104 or the second appliance 105 to execute a service. The operation terminal 101 is suitably a terminal such as a smartphone, a tablet-type computer, or a personal computer.

The reconciliation device 103 controls the first appliance 104 or the second appliance 105 in accordance with the control request transmitted from the operation terminal 101. The “control” as used herein refers to, for example, ON/OFF of power of various appliances, a change of a room temperature by an air conditioner, a change of brightness by an illumination appliance, or the like. Control of a household appliance is realized, for example, on the basis of a connection method such as an ECHONET Lite standard. Note that the reconciliation device 103 may permit control of the first appliance 104 or the second appliance 105.

In a case where a plurality of control requests for the first appliance 104 or the second appliance 105 compete against each other, the reconciliation device 103 reconciles the plurality of control requests. That is, in a case where control requests for causing the first appliance 104 or the second appliance 105 to execute different services are transmitted concurrently or in a short period, the reconciliation device 103 accepts only any one of the control requests and does not accept a remaining control request. The reconciliation device 103 reconciles a plurality of control requests transmitted to cause an appliance to execute a plurality of respective different services.

A communication network 102 is a local area network in a house. The operation terminal 101, the reconciliation device 103, the first appliance 104, and the second appliance 105 are communicably connected to one another over the communication network 102. Note that the communication network 102 may be a wired network or may be a wireless network. A communication medium for constructing the communication network 102 is not limited in particular. Furthermore, the communication network 102 may be connected to a broader communication network. For example, the communication network 102 may be connected to the Internet via a broadband router or the like in the house.

FIG. 2 is a diagram illustrating an example of a hardware configuration of the reconciliation device 103 according to Embodiment 1 of the present disclosure. The reconciliation device 103 includes a processor 201, a memory 202, a storage unit 203, an input/output unit 204, and a communication unit 205. The memory 202 is realized by a volatile storage device such as a RAM (Random Access Memory). The storage unit 203 is realized by a non-volatile storage device such as a HDD (Hard Disk Drive), an SSD (Solid State Drive), or a flash memory. The reconciliation device 103 is connected to the operation terminal 101, the first appliance 104, and the second appliance 105 over the communication network 102.

In FIG. 1, the reconciliation device 103 is illustrated as an independent single device. However, the reconciliation device 103 may be integral with another device such as the operation terminal 101, the first appliance 104, the second appliance 105, or the broadband router in the house.

In FIG. 1, the appliance control system includes a single reconciliation device 103, but the present disclosure is not limited to this in particular, and the appliance control system may include a plurality of reconciliation devices. The appliance control system includes a single operation terminal 101, but the present disclosure is not limited to this in particular, and the appliance control system may include a plurality of operation terminals. The appliance control system includes two appliances 104 and 105, but the present disclosure is not limited to this in particular, and the appliance control system may include three or more appliances.

Next, a more specific embodiment of service execution control using a reconciliation device according to the present disclosure is described.

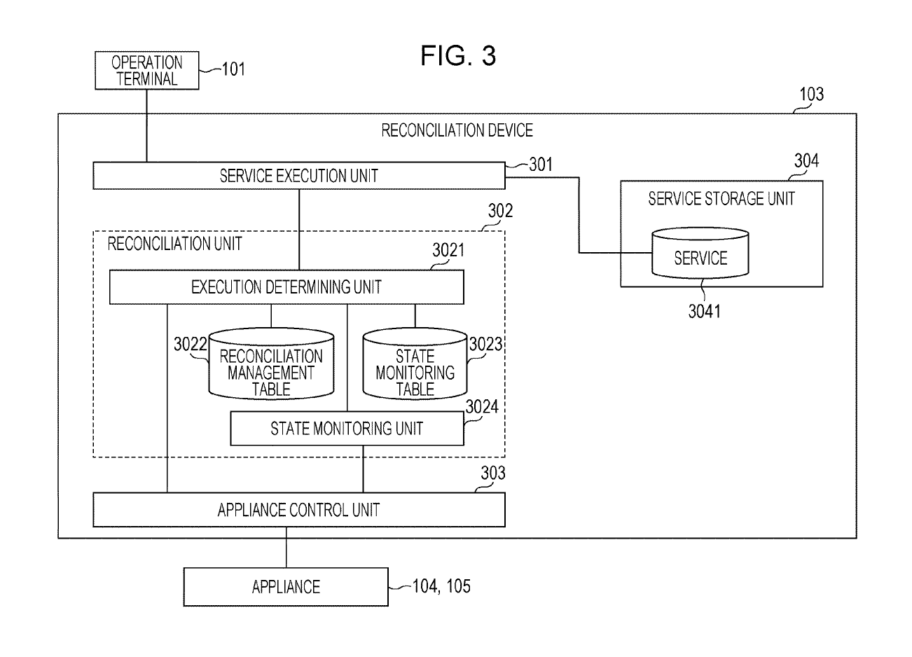

FIG. 3 is a diagram illustrating an example of a detailed configuration of a reconciliation device according to Embodiment 1 of the present disclosure. The reconciliation device 103 includes a service execution unit 301, a reconciliation unit 302, an appliance control unit 303, and a service storage unit 304. In more detail, the reconciliation unit 302 includes an execution determining unit 3021, a reconciliation management table 3022, a state monitoring table 3023, and a state monitoring unit 3024.

The service execution unit 301 issues, to the execution determining unit 3021, a control request based on a user's instruction received from the operation terminal 101. Furthermore, the service execution unit 301 notifies the operation terminal 101 of a control result on the basis of information received from the execution determining unit 3021 after issuance of the control request.

The execution determining unit 3021 determines whether or not a service indicated by the control request is executable on the basis of the control request received from the service execution unit 301 and information stored in the state monitoring table 3023 and the reconciliation management table 3022. A detailed operation of the execution determining unit 3021 will be described later.

The reconciliation management table 3022 holds information necessary to reconcile a plurality of control requests that compete against each other.

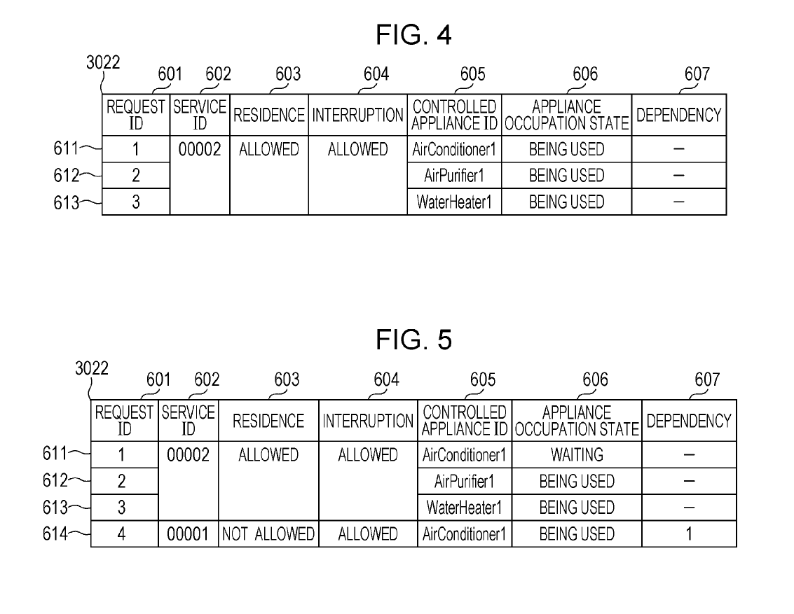

FIG. 4 is a diagram illustrating an example of a reconciliation management table according to Embodiment 1 of the present disclosure, and FIG. 5 is a diagram illustrating another example of a reconciliation management table according to Embodiment 1 of the present disclosure. A request ID 601 is a unique identifier given to all appliances controlled by a service. A service ID 602 is a unique identifier given to a service. Residence 603 is information indicating whether or not a service is resident. That is, in a case where the residence 603 of a service is “possible”, the service acquires a control right when another service releases the control right in a situation where control for executing the service and control for executing the other service compete against each other and the control right of the service has been handed over to the other service.

Interruption 604 indicates whether or not a service permits interruption. That is, in a case where the interruption 604 of a service is “possible”, a control right of the service is handed over to another service upon occurrence of competition between control for executing the service and control for executing the other service.

A controlled appliance ID 605 is a unique identifier associated with a controlled appliance. An appliance occupation state 606 indicates whether or not a service holds a control right of an appliance indicated by the controlled appliance ID 605. In a case where the appliance occupation state 606 of a service is “being used”, the service has acquired the control right of the appliance. Meanwhile, in a case where the appliance occupation state 606 of a service is “not used”, the service has released the control right of the appliance after acquiring the control right. Meanwhile, in a case where the appliance occupation state 606 of a service is “waiting”, the service has handed the control right of the appliance over to another service and is waiting for release of the control right of the appliance that executes the other service.

Dependency 607 is an entry for specifying a control request that is an original holder of a control right in a case where control for executing a service and control for executing another service compete against each other and where the other service has acquired the control right. The request ID 601 in the reconciliation management table 3022 is stored as a value of the dependency 607.

In the following description, it is assumed that an uppermost entry in the reconciliation management table 3022 is oldest, and a new entry is always added to a bottom of the reconciliation management table 3022. Details of each entry of the reconciliation management table 3022 will be described later.

The state monitoring table 3023 in FIG. 3 holds information necessary to execute a service and to determine termination of appliance control.

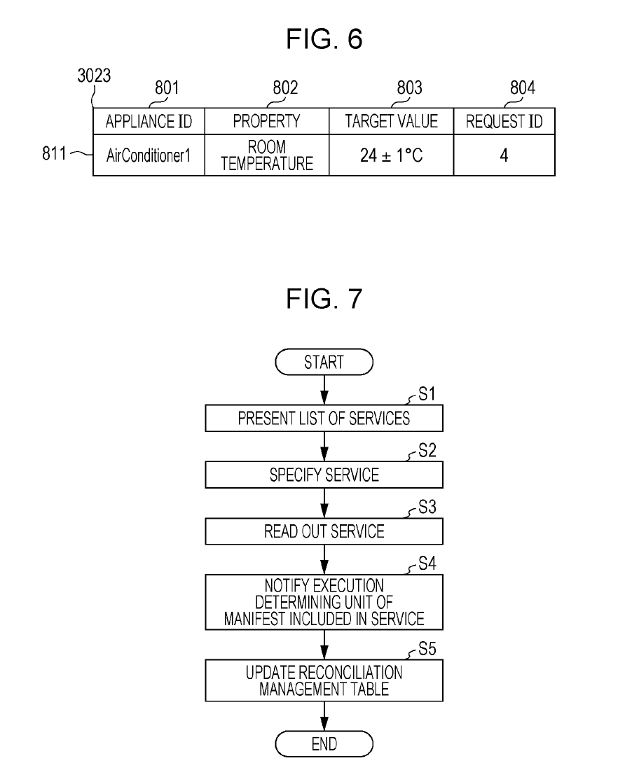

FIG. 6 is a diagram illustrating an example of the state monitoring table 3023 according to Embodiment 1 of the present disclosure. An appliance ID 801 is a unique identifier associated with an appliance controlled by a service. A property 802 is information indicative of an appliance state (a controlled item) that is monitored to execute a service and to determine termination of appliance control. The appliance state is, for example, a room temperature, a room humidity, or the like. A target value 803 is information indicating a value of the property 802 that is a criterion on which a service is executed and appliance control is terminated. A request ID 804 is a unique identifier that has the same meaning as the entry of the same name in the reconciliation management table 3022. Details of each entry of the state monitoring table 3023 will be described later.

The state monitoring unit 3024 monitors a service execution state of an appliance on the basis of contents of the state monitoring table 3023 and a state of the controlled appliance received from the appliance control unit 303. Note that a detailed operation of the state monitoring unit 3024 will be described later.

The appliance control unit 303 transmits a control request to the first appliance 104 and/or the second appliance 105 and receives a service execution state from the first appliance 104 and/or the second appliance 105 in response to a request from the reconciliation unit 302.

The service storage unit 304 stores therein information concerning a service 3041 that operates in the reconciliation device 103.

The appliance control unit 303 controls a first appliance on the basis of a first control request for executing a first service among a plurality of services. The appliance control unit 303 may accept the first control request for executing the first service among the plurality of services and permit control of the first appliance based on the first control request. The state monitoring unit 3024 acquires space estimation information for estimating a state of a space relevant with continuation or termination of the first service. The execution determining unit 3021 determines whether or not the state of the space estimated on the basis of the space estimation information is a state that should be satisfied by the first service. In a case where it is determined that the state of the space is not the state that should be satisfied by the first service, the appliance control unit 303 does not accept a second control request for causing the first appliance to execute a second service different from the first service.

Meanwhile, in a case where it is determined that the state of the space is the state that should be satisfied by the first service, the appliance control unit 303 accepts the second control request. Then, the appliance control unit 303 controls the first appliance on the basis of the second control request. Note that the appliance control unit 303 may permit control of the first appliance based on the second control request.

The space estimation information is acquired from the first appliance. Alternatively, the space estimation information may be acquired from a second appliance different from the first appliance. The space estimation information is information of the same kind as a property for controlling the first appliance that is included in the first control request. Alternatively, the space estimation information may be information of a different kind from a property for controlling the first appliance that is included in the first control request.

The service execution unit 301, the reconciliation unit 302, the appliance control unit 303, and the service storage unit 304 are suitably realized in a manner such that a software program (specifically, an application program described in a language such as HTML5 or JavaScript (Registered Trademark)) stored in the storage unit 203 of the reconciliation device 103 is loaded into the memory 202, and the loaded software program is executed by the processor 201. However, this is an example, and for example, the processor 201 of the reconciliation device 103 may acquire a software program stored in an external server or the like instead of the storage unit 203 via the communication unit 205.

Next, an example of a procedure of execution of a service by the reconciliation device 103 is described with reference to FIG. 7.

FIG. 7 is a flow chart for explaining an example of a procedure of execution of a service by the reconciliation device 103.

First, in Step S1, the service execution unit 301 presents a list of services to the operation terminal 101. The list of services includes at least information (e.g., service names and explanations of the services) that allows a user to distinguish the services. That is, the list of services is a list of services that are executable by the first appliance 104 or the second appliance 105 connected to the reconciliation device 103. The service execution unit 301 reads out information concerning the list of services from the service storage unit 304 and then transmits the information concerning the list of services to the operation terminal 101. The operation terminal 101 receives the list of services transmitted from the reconciliation device 103 and displays the received list of services in a selectable manner. The operation terminal 101 accepts user's selection of a desired service from among the services in this list thus displayed. The user selects a desired service from among the presented services in the list. The operation terminal 101 transmits, to the reconciliation device 103, information that specifies the service selected by the user from among the services in the list.

Next, in Step S2, the service execution unit 301 receives the information that specifies the service selected by the user from the operation terminal 101 and thus specifies the service selected by the user.

Next, in Step S3, the service execution unit 301 reads out a service 3041 thus specified from the service storage unit 304. The service 3041 includes a manifest (definition file) that defines a service attribute.

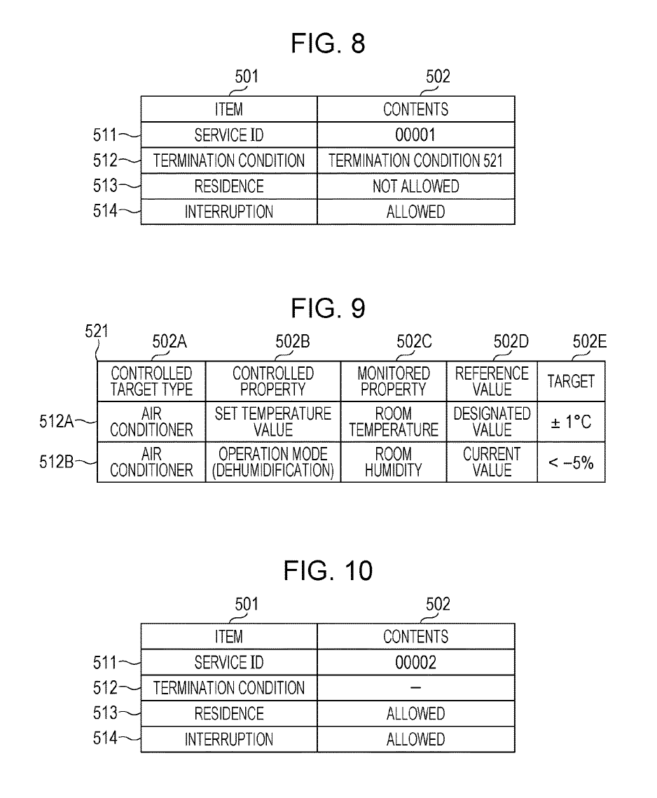

FIG. 8 is a diagram illustrating an example of a configuration of a manifest that defines attributes of a service, FIG. 9 is a diagram illustrating an example of a termination condition in the manifest, and FIG. 10 is a diagram illustrating an example of a configuration of a manifest having no termination condition.

As illustrated in FIG. 8, the manifest is expressed by a pair of item 501 and contents 502 and is constituted by the following entries: a service ID 511 that uniquely distinguish a service, a termination condition 512 that defines a termination condition of appliance control by the service, residence 513 that indicates whether or not the service is a resident service, and interruption 514 that indicates whether or not the service can be interrupted.

The termination condition 512 is a condition on which a service releases a control right in a situation where appliance control for executing the service and appliance control for executing another service compete against each other and where the service has acquired the control right. As illustrated in FIG. 9, the termination condition 521 is constituted by the following entries: a controlled target type 502A indicative of a type of a controlled appliance such as an air conditioner or an illumination appliance, a controlled property 502B indicative of a type of appliance control that triggers determination of a termination condition of the appliance control, a monitored property 502C to be compared in determination of the termination condition of the appliance control, a reference value 502D used as a reference value in determination of the condition, and a target 502E that is a target value in determination of the condition.

For example, a row 512A in FIG. 9 indicates that in a case where a service for changing a set temperature value of an air conditioner is executed, a room temperature is monitored and it is determined that appliance control is terminated when a current value of the room temperature falls within a range of ±1° C. of a value designated at the time of a control request. Similarly, a row 512B in FIG. 9 indicates that in a case where a service for changing an operation mode of an air conditioner to “dehumidification” is executed, a room humidity is monitored and it is determined that appliance control is terminated when a current value of the room humidity becomes lower by 5% than a value of a room humidity obtained at the time of a control request. Note that the contents 502 of the termination condition 512 may be blank as illustrated in FIG. 10. This means that appliance control does not have an explicit termination condition.

See FIG. 7 again. After the service 3041 is read out from the service storage unit 304, the service execution unit 301 notifies the execution determining unit 3021 of the manifest included in the service 3041 in Step S4.

Finally, in Step S5, the execution determining unit 3021 updates the reconciliation management table 3022 in accordance with the received manifest. The update means that rows of a service ID, residence, and interruption are read out from a manifest that defines attributes of a service and are then stored in corresponding columns of the reconciliation management table 3022, respectively. This is described by using FIGS. 10 and 4 as an example. The service ID 511 in FIG. 10 is stored in the service ID 602 in FIG. 4, the residence 513 in FIG. 10 is stored in the residence 603 in FIG. 4, and the interruption 514 in FIG. 10 is stored in the interruption 604 in FIG. 4. Other columns in FIG. 4 are not manipulated at this point in time and will be described later.

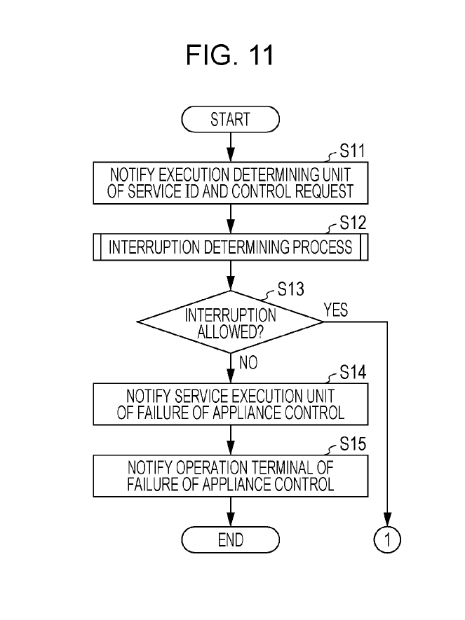

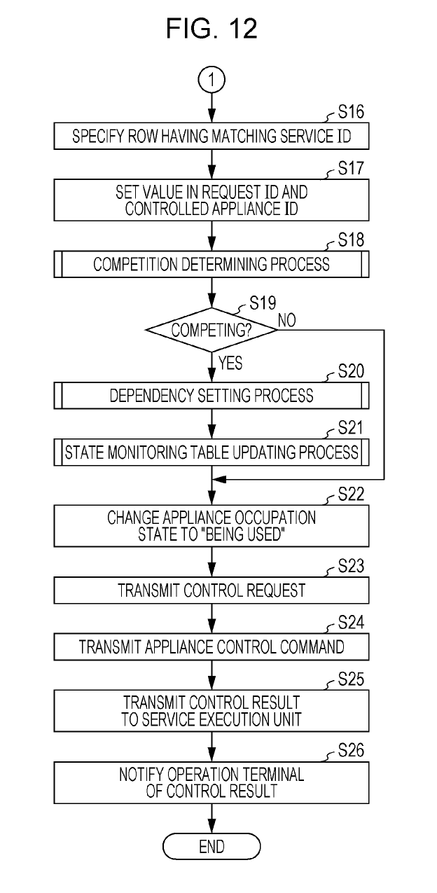

Next, a flow of processes of the reconciliation device 103 performed in a case where an appliance executes a service is described with reference to FIGS. 11 and 12. FIG. 11 is a first flow chart for explaining a flow of processes of the reconciliation device performed in a case where an appliance executes a service, and FIG. 12 is a second flow chart for explaining a flow of processes of the reconciliation device performed in a case where an appliance executes a service.

In the following description, it is, for example, assumed that a service having the manifest of FIG. 8 is executed in an air conditioner (appliance ID: AirConditioner1) in a house, and a service having the manifest of FIG. 10 is executed in three appliances, i.e., an air conditioner (appliance ID: AirConditioner1), an air purifier (appliance ID: AirPurifier1), and a water heater (appliance ID: WaterHeater1) in the house. Note that it is assumed that no service is executed initially in any of the appliances, and a user first causes the service having the manifest of FIG. 10 (preceding service) to be executed and then causes the service having the manifest of FIG. 8 (succeeding service) to be executed, for example, by operating an application operating in the operation terminal 101.

Upon receipt of a control request for causing the appliances to execute the preceding service, the service execution unit 301 notifies the execution determining unit 3021 of a service ID and the control request of the preceding service in Step S11. The control request includes at least appliance IDs of all of the appliances to be controlled by the preceding service and information on properties to be controlled. That is, in the case of the preceding service in the present embodiment, the control request includes appliance IDs of the air conditioner (appliance ID: AirConditioner1), the air purifier (appliance ID: AirPurifier1), and the water heater (appliance ID: WaterHeater1) and information on properties to be controlled. In such a case where a service is executed in a plurality of appliances, the execution determining unit 3021 sequentially performs a process for each of the plurality of appliances.

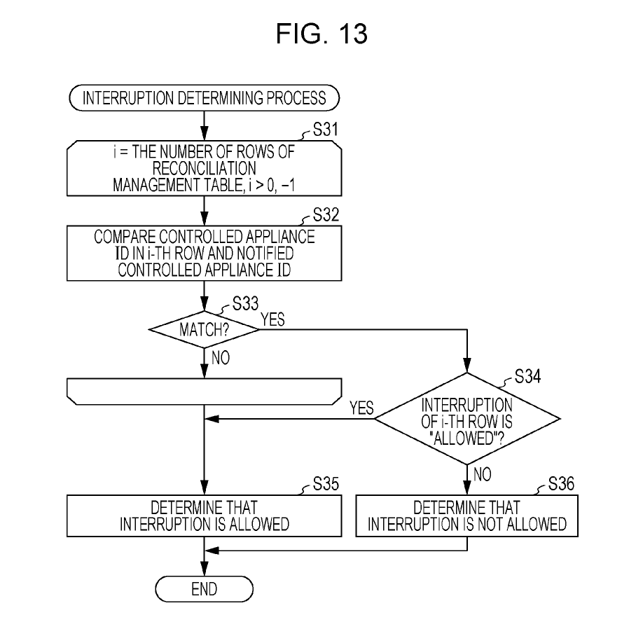

Next, in Step S12, the execution determining unit 3021 determines, for the control request, whether or not interruption is allowed. Details of the interruption determining process in Step S12 is described below. FIG. 13 is a flow chart for explaining the interruption determining process in Step S12 of FIG. 11.

In Step S31 of the interruption determining process, the execution determining unit 3021 inspects all rows of the reconciliation management table 3022.

First, in Step S32, the execution determining unit 3021 compares a controlled appliance ID 605 of an i-th row of the reconciliation management table 3022 and the controlled appliance ID of which the execution determining unit 3021 has been notified by the service execution unit 301.

Next, in Step S33, the execution determining unit 3021 determines whether or not the controlled appliance ID 605 of the i-th row and the controlled appliance ID of which the execution determining unit 3021 has been notified by the service execution unit 301 match each other. In a case where it is determined that the controlled appliance ID 605 of the i-th row and the controlled appliance ID of which the execution determining unit 3021 has been notified by the service execution unit 301 do not match each other (NO in Step S33), the execution determining unit 3021 returns to the process in Step S31 and inspects a next row in the reconciliation management table 3022.

Meanwhile, in a case where it is determined that the controlled appliance ID 605 of the i-th row and the controlled appliance ID of which the execution determining unit 3021 has been notified by the service execution unit 301 match each other (YES in Step S33), the execution determining unit 3021 determines in Step S34 whether or not the interruption 604 of the i-th row that is being inspected is “allowed”. In a case where it is determined that the interruption 604 of the i-th row is “allowed” (YES in Step S34), the execution determining unit 3021 determines in Step S35 that interruption is allowed and finishes the process.

Meanwhile, in a case where it is determined that the interruption 604 of the i-th row is not “allowed” (NO in Step S34), the execution determining unit 3021 determines in Step S36 that interruption is not allowed and finishes the process. Also in a case where it is determined in Step S33 that the controlled appliance ID 605 and the controlled appliance ID of which the execution determining unit 3021 has been notified by the service execution unit 301 do not match each other in all of the rows of the reconciliation management table 3022, the execution determining unit 3021 determines that interruption is allowed and finishes the process.

See FIG. 11 again. In Step S13, the execution determining unit 3021 determines whether or not interruption is allowed as a result of the interruption determining process. In a case where it is determined that interruption is not allowed (NO in Step S13), the execution determining unit 3021 notifies the service execution unit 301 of failure of appliance control in Step S14.

Next, in Step S15, the service execution unit 301 notifies the operation terminal 101 of failure of appliance control and finishes the process.

Meanwhile, in a case where it is determined in Step S13 that interruption is allowed (YES in Step S13), the execution determining unit 3021 searches the reconciliation management table 3022 and specifies a row having a matching service ID in Step S16.

Next, in Step S17, the execution determining unit 3021 sets a value in the request ID 601 and the controlled appliance ID 605 in the row having the matching service ID. A specific form of the value set in the request ID 601 is not limited, as long as the value is unique in the reconciliation management table 3022. The value set in the controlled appliance ID 605 is the controlled appliance ID of which the execution determining unit 3021 has been notified by the service execution unit 301. Note that in a case where a controlled appliance ID of another appliance has been already stored in the entry of the controlled appliance ID 605 in the row specified in Step S16, the execution determining unit 3021 adds a new row to the reconciliation management table 3022 and copies the contents in the service ID 602, the residence 603, and the interruption 604 into the new row. Then, the execution determining unit 3021 sets a value in the request ID 601 and the controlled appliance ID 605 in the new row.

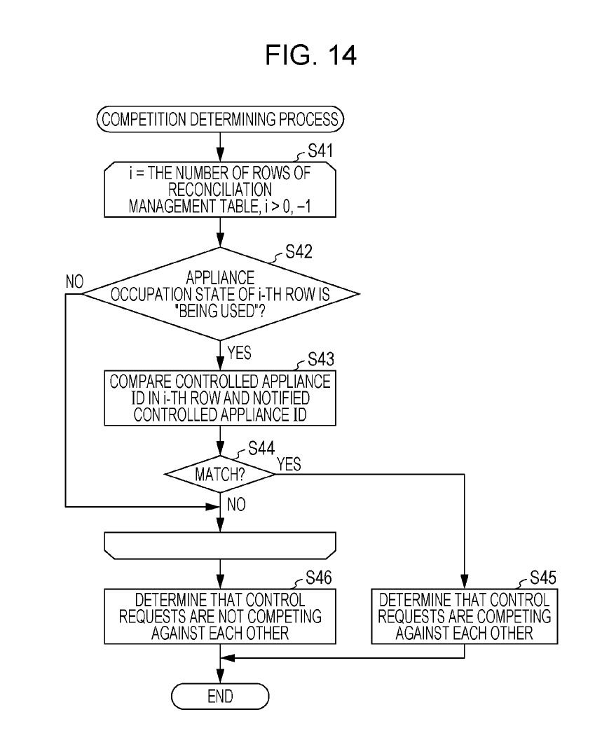

Next, in Step S18, the execution determining unit 3021 determines whether or not a control request competes against the control request of which the execution determining unit 3021 has been notified. Details of the competition determining process in Step S18 are described below. FIG. 14 is a flow chart for explaining the competition determining process in Step S18 of FIG. 12.

In Step S41 of the competition determining process, the execution determining unit 3021 inspects all rows of the reconciliation management table 3022.

First, in Step S42, the execution determining unit 3021 determines whether or not the appliance occupation state 606 of the i-th row of the reconciliation management table 3022 is “being used”. In a case where it is determined that the appliance occupation state 606 is not “being used” (NO in Step S42), the execution determining unit 3021 returns to the process in Step S41 and inspects a next row of the reconciliation management table 3022.

Meanwhile, in a case where it is determined that the appliance occupation state 606 is “being used” (YES in Step S42), the execution determining unit 3021 compares, in Step S43, the controlled appliance ID 605 of the i-th row that is being inspected and the controlled appliance ID of which the execution determining unit 3021 has been notified by the service execution unit 301.

Next, in Step S44, the execution determining unit 3021 determines whether or not the controlled appliance ID 605 of the i-th row and the controlled appliance ID of which the execution determining unit 3021 has been notified match each other. In a case where it is determined that the controlled appliance ID 605 of the i-th row and the controlled appliance ID of which the execution determining unit 3021 has been notified do not match each other (NO in Step S44), the execution determining unit 3021 returns to the process in Step S41 and inspects a next row in the reconciliation management table 3022.

Meanwhile, in a case where it is determined that the controlled appliance ID 605 of the i-th row and the controlled appliance ID of which the execution determining unit 3021 has been notified match each other (YES in Step S44), the execution determining unit 3021 determines in Step S45 that control requests are competing against each other and finishes the process.

Meanwhile, in a case where it is determined in Step S44 that the controlled appliance ID 605 and the controlled appliance ID of which the execution determining unit 3021 has been notified do not match each other in all of the rows of the reconciliation management table 3022, the execution determining unit 3021 determines in Step S46 that control requests are not competing against each other and finishes the process.

See FIG. 12 again. In Step S19, the execution determining unit 3021 determines as a result of the competition determining process whether or not control requests are competing against each other. In a case where it is determined that control requests are competing against each other (YES in Step S19), the execution determining unit 3021 executes a dependency setting process in Step S20. Next, in Step S21, the execution determining unit 3021 executes a state monitoring table updating process. Note that no service is executed initially, and therefore there is no possibility that control requests compete against each other. Therefore, details of the dependency setting process and the state monitoring table updating process will be described later.

After the state monitoring table updating process is finished or in a case where it is determined that control requests are not competing against each other (NO in Step S19), the execution determining unit 3021 changes the appliance occupation state 606 in the row specified in Step S16 to “being used” in Step S22.

Next, in Step S23, the execution determining unit 3021 transmits the control request to the appliance control unit 303.

Next, in Step S24, the appliance control unit 303 receives the control request and then transmits an appliance control command for controlling an appliance to the appliance. The appliance receives the appliance control command and then executes a service in accordance with the received appliance control command. Then, the appliance transmits a control result to the reconciliation device 103 as a response to the appliance control command. The appliance control unit 303 receives the control result transmitted by the appliance.

Next, when the appliance control unit 303 receives the control result from the appliance, the execution determining unit 3021 transmits the control result to the service execution unit 301 in Step S25.

Next, in Step S26, the service execution unit 301 notifies the operation terminal 101 of the control result and finishes the process. A state of the reconciliation management table 3022 obtained after the preceding service is executed through the above processes is illustrated in FIG. 4. Since no service is executed initially in any of the appliances, the appliance occupation state 606 in all rows of the reconciliation management table 3022 is “being used”.

Next, a flow of processes performed in a case where an appliance is caused to execute a succeeding service is described with reference to FIGS. 11 and 12.

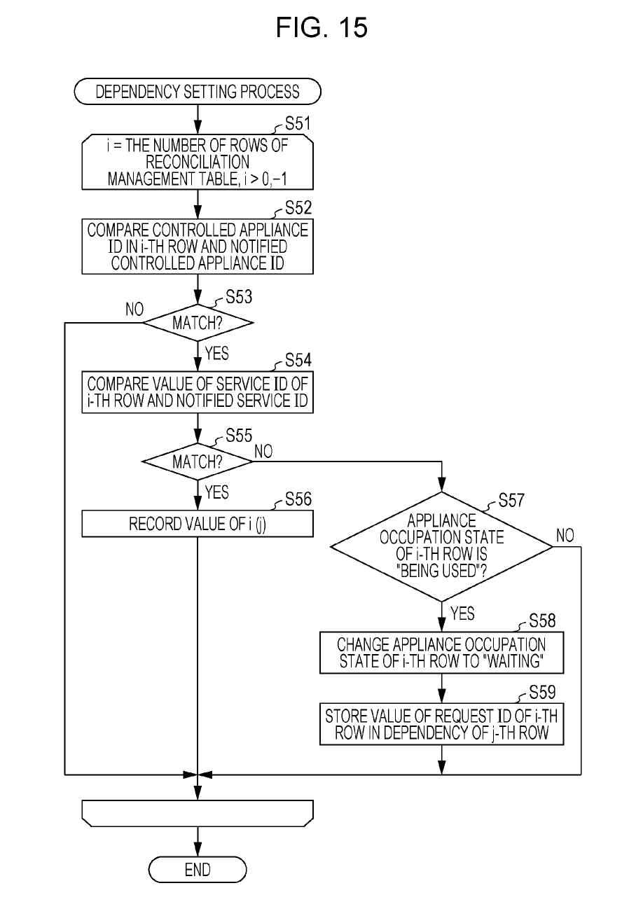

First, the processes in Steps S11 through S17 are similar to the aforementioned processes, and therefore description thereof is omitted. The competition determining process in Step S18 is also similar to the aforementioned process, but the preceding service and the succeeding service are executed in the same air conditioner (appliance ID: AirConditioner1) in the house. Accordingly, it is determined in Step S44 of FIG. 14 that the controlled appliance ID 605 of the i-th row and the controlled appliance ID of which the execution determining unit 3021 has been notified match each other, and the execution determining unit 3021 determines in Step S45 that control requests are competing against each other and finishes the process. As a result, it is determined in Step S19 of FIG. 12 that control requests are competing against each other, and the execution determining unit 3021 executes the dependency setting process and the state monitoring table updating process. First, details of the dependency setting process in Step S20 are described. FIG. 15 is a flow chart for explaining the dependency setting process in Step S20 of FIG. 12.

In Step S51 of the dependency setting process, the execution determining unit 3021 inspects all of the rows of the reconciliation management table 3022.

First, in Step S52, the execution determining unit 3021 compares the controlled appliance ID 605 of the i-th row of the reconciliation management table 3022 and the controlled appliance ID of which the execution determining unit 3021 has been notified by the service execution unit 301.

Next, in Step S53, the execution determining unit 3021 determines whether or not the controlled appliance ID 605 of the i-th row and the controlled appliance ID of which the execution determining unit 3021 has been notified match each other. In a case where it is determined that the controlled appliance ID 605 of the i-th row and the controlled appliance ID of which the execution determining unit 3021 has been notified do not match each other (NO in Step S53), the execution determining unit 3021 returns to the process in Step S51 and inspects a next row in the reconciliation management table 3022.

Meanwhile, in a case where it is determined that the controlled appliance ID 605 of the i-th row and the controlled appliance ID of which the execution determining unit 3021 has been notified match each other (YES in Step S53), the execution determining unit 3021 compares, in Step S54, a value of the service ID 602 of the i-th row that is being inspected and the service ID of which the execution determining unit 3021 has been notified by the service execution unit 301.

Next, in Step S55, the execution determining unit 3021 determines whether or not the value of the service ID 602 of the i-th row and the service ID of which the execution determining unit 3021 has been notified match each other. In a case where it is determined that the value of the service ID 602 of the i-th row and the service ID of which the execution determining unit 3021 has been notified match each other (YES in Step S55), the execution determining unit 3021 records the position of the row (the value of i) that is being inspected in Step S56, returns to the process in Step S51, and inspects a next row in the reconciliation management table 3022. In this example, it is assumed that a row number recorded in Step S56 is j.

Meanwhile, in a case where it is determined that the value of the service ID 602 of the i-th row and the service ID of which the execution determining unit 3021 has been notified do not match each other (NO in Step S55), the execution determining unit 3021 determines in Step S57 whether or not the appliance occupation state 606 of the i-th row that is being inspected is “being used”. In a case where it is determined that the appliance occupation state 606 is not “being used” (NO in Step S57), the execution determining unit 3021 returns to the process in Step S51 and inspects a next row in the reconciliation management table 3022.

Meanwhile, in a case where it is determined that the appliance occupation state 606 is “being used” (YES in Step S57), the execution determining unit 3021 changes the appliance occupation state 606 of the i-th row to “waiting” in Step S58.

Next, in Step S59, the execution determining unit 3021 causes the value of the request ID 601 of the i-th row that is being inspected to be stored in the dependency 607 of the j-th row that is the row number recorded previously, returns to the process in Step S51, and inspects a next row in the reconciliation management table 3022. In the above description, the process in Step S57 has been executed prior to the process in Step S59, and as a result, the value of a variable j used as a row number of the dependency 607 in which the value of the request ID 601 is stored has already been obtained at the time of the process in Step S59. However, it is also possible to employ an arrangement in which a row number is recorded (e.g., a k-th row) when the process in Step S59 is executed earlier, and the value of the variable k is used when the process in Step S57 is executed later. An example of the state of the reconciliation management table 3022 at the end of the dependency setting process is illustrated in FIG. 5.

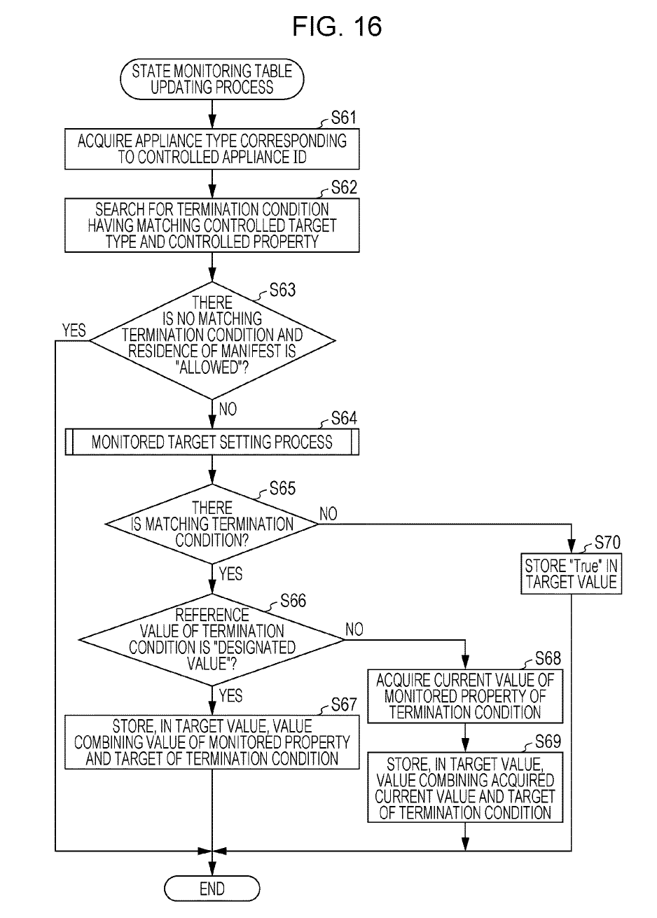

Next, details of the state monitoring table updating process in Step S21 of FIG. 12 are described with reference to FIGS. 6 and 16. FIG. 16 is a flow chart for explaining the state monitoring table updating process in Step S21 of FIG. 12.

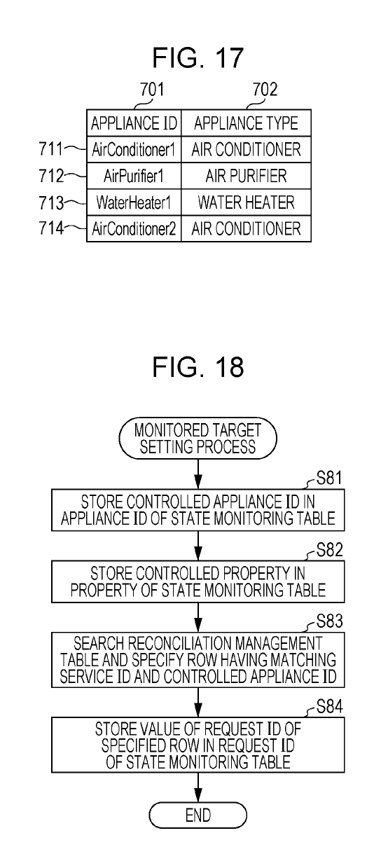

First, in Step S61 of the state monitoring table updating process, the execution determining unit 3021 acquires an appliance type corresponding to the controlled appliance ID of which the execution determining unit 3021 has been notified by the service execution unit 301. In order to realize the process in Step S61, for example, the storage unit 203 of the reconciliation device 103 holds a correspondence table like the one illustrated in FIG. 17. FIG. 17 is a diagram illustrating an example of a correspondence table in which appliance IDs and appliance types are associated with each other according to Embodiment 1 of the present disclosure. In the correspondence table illustrated in FIG. 17, information of a single appliance is managed in each row, and a new entry is added when an appliance is registered in the reconciliation device 103 or when an appliance is paired with the reconciliation device 103. In this example, it is assumed that the appliance type 702 is associated with a category such as a class of an appliance object of an ECHONET Lite standard. In this example, since the air conditioner in the house executes the succeeding service, and the appliance ID of the air conditioner is “AirConditioner1”, the execution determining unit 3021 acquires the appliance type “air conditioner” in a row 711 illustrated in FIG. 17 as a result of the process in Step S61.

Next, in Step S62, the execution determining unit 3021 searches for a termination condition having matching controlled target type and controlled property from the termination condition 521 of the manifest of the service. For example, in a case where the control request changes a controlled property “set temperature value”, the termination condition in the row 512A matches as a result of search of the controlled target type 502A and the controlled property 502B in the termination condition 521 in the process in Step S62.

Next, in Step S63, the execution determining unit 3021 determines whether or not there is no matching termination condition and residence of the manifest is “allowed”. In a case where there is no matching termination condition and residence of the manifest is “allowed” (YES in Step S63), the process is finished. That is, an entry of the state monitoring table is not created for a service that has no description of a termination condition in the manifest and is resident. This makes it possible to continue occupation of a control right of an appliance without monitoring appliance control at all.

Meanwhile, in a case where there is no matching termination condition and residence of the manifest is not “allowed”, in a case where there is a matching termination condition and residence of the manifest is “allowed”, or in a case where there is a matching termination condition and residence of the manifest is not “allowed” (NO in Step S63), the execution determining unit 3021 executes a monitored target setting process for setting information on a monitored target in Step S64. Details of the monitored target setting process in Step S64 are described below. FIG. 18 is a flow chart for explaining the monitored target setting process in Step S64 of FIG. 16.

First, in Step S81 of the monitored target setting process, the execution determining unit 3021 causes the controlled appliance ID included in the control request of which the execution determining unit 3021 has been notified by the service execution unit 301 to be stored in the appliance ID 801 of the state monitoring table 3023.

Next, in Step S82, the execution determining unit 3021 causes the controlled property included in the control request of which the execution determining unit 3021 has been notified by the service execution unit 301 to be stored in the property 802 of the state monitoring table 3023.

Next, in Step S83, the execution determining unit 3021 specifies a row in which both a service ID and a controlled appliance ID match with the service ID of which the execution determining unit 3021 has been notified by the service execution unit 301 and the controlled appliance ID stored in the Step S81 match by searching the reconciliation management table 3022.

Next, in Step S84, the execution determining unit 3021 causes the value of the request ID 601 in the specified row to be stored in the request ID 804 of the state monitoring table 3023 and finishes the process.

See FIG. 16 again. After the monitored target setting process is finished, the execution determining unit 3021 determines in Step S65 whether or not there is a termination condition having matching controlled target type and controlled property in the process in Step S62. In a case where it is determined that there is a matching termination condition (YES in Step S65), the execution determining unit 3021 determines in Step S66 whether or not the reference value 502D in a row having matching controlled target type and controlled property in the termination condition 521 is a “designated value” by referring to the reference value 502D.

In a case where it is determined that the reference value 502D is a “designated value” (YES in Step S66), the execution determining unit 3021 causes a value combining the value of the monitored property 502C designated by the control request and the target 502E of the termination condition 521 to be stored in the target value 803 of the state monitoring table 3023 in Step S67 and then finishes the process.

Meanwhile, in a case where it is determined that the reference value 502D is not a “designated value” (NO in Step S66), the execution determining unit 3021 acquires, in Step S68, a current value of the monitored property 502C of the termination condition 521 from the controlled appliance via the appliance control unit 303.

Next, in Step S69, the execution determining unit 3021 causes a value combining the acquired current value and the target 502E of the termination condition 521 to be stored in the target value 803 of the state monitoring table 3023 and then finishes the process. In this way, the target value 803 can be designated so as to monitor an absolute value by the process in Step S67 or monitor a relative value by the processes in Step S68 and Step S69.

In a case where it is determined in Step S65 that there is no matching termination condition (NO in Step S65), the execution determining unit 3021 causes a value indicating that a condition is always established to be stored in the target value 803 of the state monitoring table 3023 in Step S70 and then finishes the process. In this example, “True” is stored as an example of the value indicating that a condition is always established, but the specific value can be modified in various ways. This makes it possible to prevent a situation where in a case where a control request for executing a service that has no description of a termination condition in a manifest and is not resident interrupts a control request for executing a different service, the service continues to occupy a control right of an appliance. Note that a specific flow of processes will be described in a service monitoring process that will be described later. FIG. 6 illustrates an example of a state of the state monitoring table 3023 at the end of the state monitoring table updating process. Note that processes after the end of the state monitoring table updating process, i.e., the processes in Steps S22 through S26 of FIG. 12 are identical to those described above, and therefore description thereof is omitted.

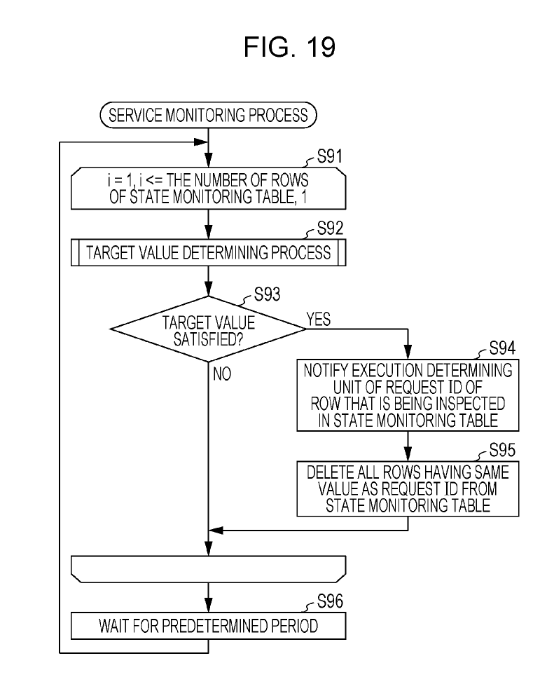

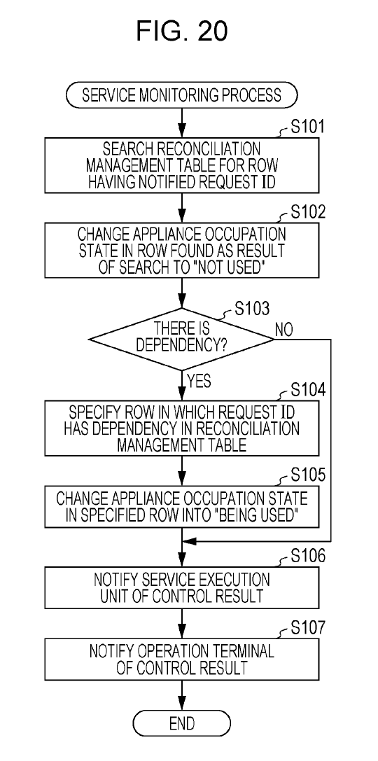

The reconciliation device 103 always executes the service monitoring process illustrated in FIGS. 19 and 20 independently of all the processes described above. First, a flow of processes executed by the state monitoring unit 3024 in order to realize the service monitoring process is described. FIG. 19 is a flow chart for explaining the service monitoring process executed by the state monitoring unit.

In Step S91 of the service monitoring process, the state monitoring unit 3024 inspects all rows of the state monitoring table 3023.

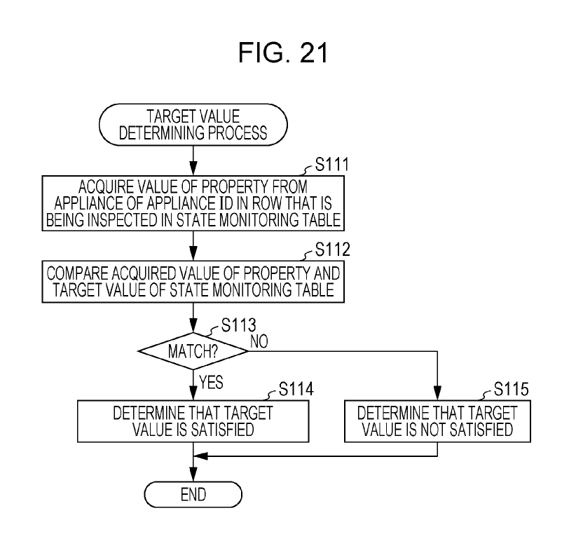

First, in Step S92, the state monitoring unit 3024 performs a target value determining process for each row of the state monitoring table 3023. Details of the target value determining process in Step S92 are described below. FIG. 21 is a flow chart for explaining the target value determining process in Step S92 of FIG. 19.

First, in Step S111 of the target value determining process, the state monitoring unit 3024 acquires a value of the property 802 from an appliance of the appliance ID 801 in a row that is being inspected in the state monitoring table 3023 via the appliance control unit 303.

Next, in Step S112, the state monitoring unit 3024 compares the acquired value of the property and a value described in the target value 803 of the state monitoring table 3023.

Next, in Step S113, the state monitoring unit 3024 determines whether or not the acquired value of the property and the value described in the target value 803 of the state monitoring table 3023 match each other. In a case where it is determined that the acquired value of the property and the value described in the target value 803 of the state monitoring table 3023 match each other (YES in Step S113), the state monitoring unit 3024 determines in Step S114 that a target value has been satisfied, and then finishes the process.

Meanwhile, in a case where it is determined that the acquired value of the property and the value described in the target value 803 of the state monitoring table 3023 do not match each other (NO in Step S113), the state monitoring unit 3024 determines in Step S115 that the target value has not been satisfied, and then finishes the process.

Note that, as an example, it is determined in Step S113 whether or not the acquired value of the property and the value described in the target value 803 of the state monitoring table 3023 match each other, but this process need not necessarily be comparison as to whether or not the values are equal to each other, and can be modified in various ways. For example, this process can be comparison as to which value is larger or comparison as to whether or not a value is within a specific range.

That is, space estimation information includes a numeric value indicative of a current state of a space. The state monitoring unit 3024 determines whether or not the numeric value is within a range of a target value indicating that the space is in a state that should be satisfied by the first service. In a case where it is determined that the numeric value is not within the range of the target value, the state monitoring unit 3024 determines that the space is not in the state that should be satisfied by the first service.

The space estimation information may include a numeric value indicative of the amount of change of the state of the space between the start of control of a first appliance based on a first control request and a current time. In this case, the state monitoring unit 3024 may determine whether or not the numeric value is within the range of the target value indicating that the space is in a state that should be satisfied by a first service. In a case where it is determined that the numeric value is not within the range of the target value, the state monitoring unit 3024 determines that the space is not in the state that should be satisfied by the first service.

In a case where there is no description in the appliance ID 801 in Step S111 or in a case where a value of the property cannot be acquired, for example, because no response to the request to acquire the value of the property 802 is given by the appliance corresponding to the appliance ID 801, the process in Step S112 may be performed after it is determined that no value has been acquired. In this case, it is determined that values match each other without comparing the values in Step S112, and then the process in Step S113 is performed. This makes it possible to prevent a situation where execution of a service is continued without releasing a control right of an appliance from which no response is obtained due to malfunction or communication cutoff.

See FIG. 19 again. Next, in Step S93, the state monitoring unit 3024 determines whether or not the value of the property in the row that is being inspected in the state monitoring table 3023 has satisfied the target value on the basis of a result of the target value determining process. In a case where it is determined that the value of the property has not satisfies the target value (NO in Step S93), the state monitoring unit 3024 inspects a next row in the state monitoring table 3023.

Meanwhile, in a case where it is determined that the value of the property has satisfied the target value (YES in Step S93), the state monitoring unit 3024 notifies the execution determining unit 3021 of the request ID 804 of the row that is being inspected in the state monitoring table 3023 in Step S94.

Next, in Step S95, the state monitoring unit 3024 deletes all rows having the same value as the request ID 804 from the state monitoring table 3023. Then, the process in Step S91 is performed again, and the state monitoring unit 3024 inspects a next row in the state monitoring table 3023. When inspection of all of the rows of the state monitoring table 3023 is completed, the state monitoring unit 3024 waits for a predetermined period in Step S96. After elapse of the predetermined period, the state monitoring unit 3024 performs the process in Step S91 again.

Note that a timing at which the process in Step S91 is performed again is not necessarily a timing after elapse of the predetermined period and may be, for example, a timing at which the state monitoring unit 3024 receives a notification issued by the appliance control unit 303 after the appliance control unit 303 receives a notification issued by an appliance upon a change of the state of the appliance. In this case, in a case where the process in Step S91 cannot be promptly performed, for example, because the repeated process in Step S91 is being performed at a timing at which the state monitoring unit 3024 receives a notification from the appliance control unit 303, the process in Step S91 may be performed again at a timing at which the repeated process is finished.

Next, a flow of processes performed in the execution determining unit 3021 in order to realize the service monitoring process is described. FIG. 20 is a flow chart for explaining the service monitoring process performed in the execution determining unit.

First, in Step S101, the execution determining unit 3021 searches the reconciliation management table 3022 for a row having the request ID of which the execution determining unit 3021 is notified by the state monitoring unit 3024.

Next, in Step S102, the execution determining unit 3021 changes the appliance occupation state 606 in the row found as a result of the search to “not used”.

Next, in Step S103, the execution determining unit 3021 determines whether or not there is dependency on another request ID by determining whether or not a value is stored in the dependency 607 in the row found as a result of the search. In a case where it is determined that no value is stored in the dependency 607, i.e., in a case where it is determined that there is no dependency on another request ID (NO in Step S103), the execution determining unit 3021 notifies the service execution unit 301 of a control result in Step S106.

Next, in Step S107, the service execution unit 301 notified of the control result notifies the operation terminal 101 of the control result and then finishes the process.

Meanwhile, in a case where it is determined in Step S103 that a value is stored in the dependency 607, i.e., in a case where it is determined in Step S103 that there is dependency on another request ID (YES in Step S103), the execution determining unit 3021 specifies a row in which the same value as that stored in the dependency 607 is stored in the request ID 601 by searching the reconciliation management table 3022 in Step S104.

Next, in Step S105, the execution determining unit 3021 changes the appliance occupation state 606 in the specified row to “being used”.

Next, in Step S106, the execution determining unit 3021 notifies the service execution unit 301 of a control result.

Next, in Step S107, the service execution unit 301 notified of the control result notifies the operation terminal 101 of the control result and then finishes the process.

It is therefore possible to explicitly designate an occupation period of an appliance. This makes it possible to control the appliance in accordance with a purpose of the appliance control by a service, an environment in a room that changes as a result of execution of a service, or the like, thereby improving user's convenience.

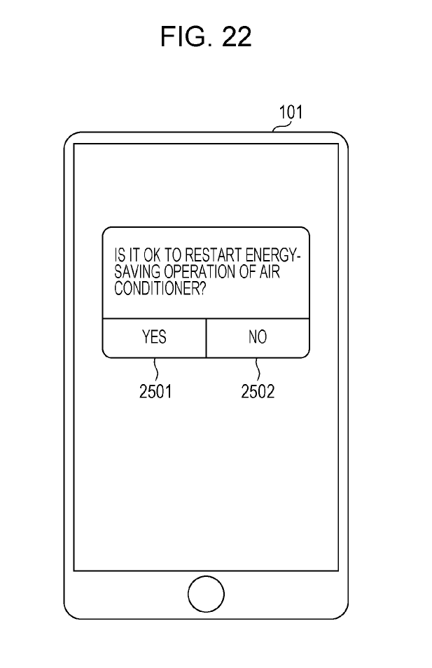

In the description of Step S93 of FIG. 19, appliance control is always terminated when a value of a property satisfies a target value and thus a termination condition of a service is satisfied. Note, however, that a user may be asked for confirmation as to whether or not appliance control is terminated at the time of termination of the appliance control. This is realized, for example, by displaying a notification screen illustrated in FIG. 22 on the operation terminal 101 at the end of the process in Step S93.

FIG. 22 is a diagram illustrating an example of a notification screen for user's confirmation as to whether or not appliance control is terminated. On the notification screen of the operation terminal 101, for example, a message “IS IT OK TO RESTART ENERGY-SAVING OPERATION OF AIR CONDITIONER.”, a positive option 2501, and a negative option 2502 are displayed. In a case where the user selects the option 2501, appliance control that has satisfied a termination condition is terminated, and previously-performed appliance control is restarted. Meanwhile, in a case where the user selects the option 2502, appliance control that has satisfied the termination condition is continued.

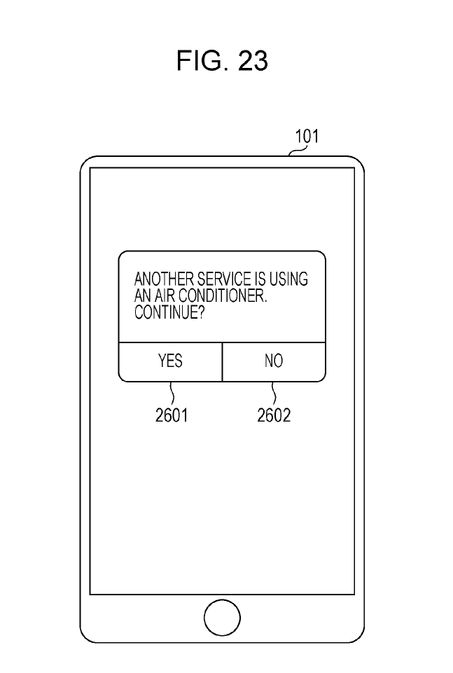

Similarly, in the description of Step S19 of FIG. 12, an interrupting service always acquires a control right of an appliance in a case where control requests compete against each other. Note, however, that a user may be asked for confirmation as to whether or not to switch an executed service in a case where control requests compete against each other. This is realized, for example, by displaying a notification screen illustrated in FIG. 23 on the operation terminal 101 at the end of the process in Step S19.

FIG. 23 is a diagram illustrating an example of a notification screen for user's confirmation as to whether or not to switch appliance control. On the notification screen of the operation terminal 101, for example, a message “ANOTHER SERVICE IS USING AIR CONDITIONER. CONTINUE?”, a positive option 2601, and a negative option 2602 are displayed. In a case where the user selects the option 2601, the process in Step S20 is performed as usual, and all of the subsequent processes are performed. Meanwhile, in a case where the user selects the option 2602, the execution determining unit 3021 deletes the request ID 601 and the controlled appliance ID 605 that are set in Step S17, notifies the service execution unit 301 of canceling of appliance control, and then finishes the process.

As described above, a manifest (service definition information) that defines contents of a first service may include a termination condition (condition definition information) that defines a state that should be satisfied by the first service. The execution determining unit 3021 determines whether or not a state of a space estimated on the basis of space estimation information is the state that should be satisfied by the first service by using the condition definition information included in the service definition information. Note that a first control request may include a termination condition (condition definition information) that defines the state that should be satisfied by the first service. In this case, the execution determining unit 3021 may determine whether or not a state of a space estimated on the basis of space estimation information is the state that should be satisfied by the first service by using condition definition information acquired from the first control request.

In the present embodiment, a termination condition of appliance control by a service is set on the basis of a value described in the termination condition 521 of a manifest. Note, however, that the value in the termination condition may be modified by the service execution unit 301 or by the operation terminal 101 operated by a user at any timing. That is, in a case where the value in the termination condition is modified by the service execution unit 301, the service execution unit 301 may, for example, set the termination condition as an argument of an appliance control API (Application Programming Interface) called up to execute a service. Meanwhile, in a case where the value in the termination condition is modified by a user's operation, the service execution unit 301 may set the termination condition before execution of a service, for example, by a user's operation of an application operating in the operation terminal 101. Furthermore, the operation terminal 101 may display a setting screen for setting the termination condition like the notification screens illustrated in FIGS. 22 and 23.

As described above, the service execution unit 301 may accept user's input of condition definition information that defines the state that should be satisfied by the first service. The execution determining unit 3021 may determine whether or not a state of a space estimated on the basis of space estimation information is the state that should be satisfied by the first service by using the accepted condition definition information.

In the present embodiment, the residence 603 and the interruption 604 in the reconciliation management table 3022 are defined for each service, but may be defined for each controlled target in which a service is executed and a more detailed condition may be set for each controlled target. For example, the residence 603 and the interruption 604 may be “allowed” only in a case where a control request for executing a different service manipulates a specific property. Alternatively, the residence 603 and the interruption 604 may be “allowed” only in a case where a control request for executing a specific service, a control request from a specific operation terminal, or a control request from a specific user competes.

In the above description, termination conditions in respective rows of the termination condition 521 are independent of each other. Note, however, that any termination conditions may be combined. That is, a termination condition may be set so that a service is terminated in a case where a plurality of termination conditions among the termination conditions in the respective rows are satisfied.

Furthermore, the monitored property 502C of the termination condition 521 may designate not only a property of a controlled appliance, but also a time. This makes it possible to terminate execution of a service after elapse of a certain period from execution of the service or from a timing at which appliance control satisfies a termination condition.

That is, the space estimation information may be an elapsed period from the start of control of the first appliance based on the first control request to a current time. In this case, the execution determining unit 3021 may determine whether or not the elapsed period is within the predetermined range and determine that a state of a space is not the state that should be satisfied by the first service in a case where it is determined that the elapsed period is not within the predetermined range. Alternatively, the space estimation information may be an elapsed period from a timing at which a state of the first appliance controlled on the basis of the first control request reaches a predetermined state to a current time. In this case, the execution determining unit 3021 determines whether or not the elapse period is within a predetermined range and determines that a state of a space is not the state that should be satisfied by the first service in a case where the elapse period is not within the predetermined range.

### Embodiment 2

In Embodiment 1 of the present disclosure, it is assumed that a controlled appliance and a monitored appliance are the same in a process of determining a termination condition of a service. Meanwhile, in a process of determining a termination condition of a service in the present embodiment 2, any number of appliances having a designated monitored property are monitored. That is, in the present embodiment 2, all appliances including an operation terminal 101, a first appliance 104, and a second appliance 105 that are connected to a communication network 102 in FIG. 1 can be appliances to be monitored.

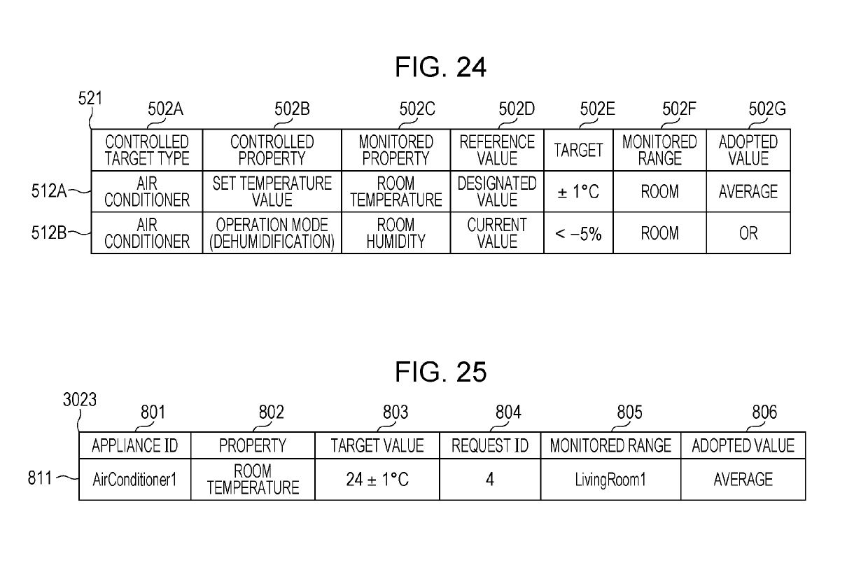

FIG. 24 is a diagram illustrating an example of a termination condition in a manifest according to Embodiment 2 of the present disclosure. In order to realize the present embodiment, a configuration of a manifest of a service is changed as illustrated in FIG. 24. That is, a termination condition 521 further includes a monitored range 502F and an adopted value 502G.

The monitored range 502F is a range in which an appliance having a designated monitored property is searched for and designates a range (space) such as “room”, “house”, or “ground floor”. The configuration of the manifest can be made logically equivalent to that in Embodiment 1 by setting “controlled appliance” as a value of the monitored range 502F so that only a controlled appliance is monitored.

The adopted value 502G is information for determining which of results of comparison between a target value 803 of a state monitoring table 3023 and a plurality of values of monitored properties acquired from a plurality of appliances within the monitored range 502F is finally adopted. For example, a value such as “AND”, “OR”, or “AVERAGE” is set in the adopted value 502G. The value “AND” indicates that all of the results are adopted (i.e., it is required that all of the plurality of values of the monitored properties acquired from the plurality of appliance within the monitored range 502F satisfy the target value 803). The value “OR” indicates that at least one result is adopted (i.e., it is required that at least one of the plurality of values of the monitored properties acquired from the plurality of appliance within the monitored range 502F satisfy the target value 803). The value “AVERAGE” indicates that the plurality of values of the monitored properties acquired from the plurality of appliance within the monitored range 502F are averaged, and a result of comparison between an average thus obtained and the target value 803 is adopted.

FIG. 25 is a diagram illustrating an example of a state monitoring table according to Embodiment 2 of the present disclosure. The state monitoring table 3023 in Embodiment 2 further includes a monitored range 805 and an adopted value 806 as illustrated in FIG. 25. Specifically, a row 811 illustrated in FIG. 25 means that states of appliances having, as a property, “room temperature”, which is a property 802, among a plurality of appliance that are present in “LivingRoom1”, which is the monitored range 805, are regularly acquired, an average of the acquired states is calculated (because the adopted value 806 is “AVERAGE”), and then the calculated average is compared with the target value 803. Note that contents of columns 502A through 502E in FIG. 24 and contents in columns 801 through 804 in FIG. 25 are similar to those in Embodiment 1, and therefore description thereof is omitted.

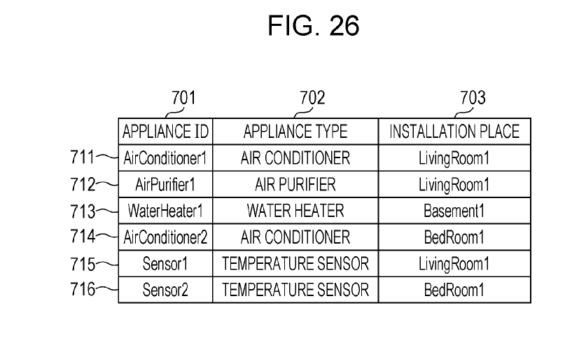

FIG. 26 is a diagram illustrating an example of a correspondence table in which appliance IDs, appliance types, and installation places are associated with one another according to Embodiment 2 of the present disclosure. In the present embodiment 2, the correspondence table illustrated in FIG. 17 in which the appliance IDs and the appliance types are associated with each other is changed as illustrated in FIG. 26. That is, each row of the correspondence table includes an installation place 703 of an appliance. The installation place 703 is a unique identifier indicative of a place where the appliance is actually placed. The installation place 703 is set by a user's operation of the operation terminal 101 when the appliance is registered in the reconciliation device 103 or when the appliance is paired with the reconciliation device 103.

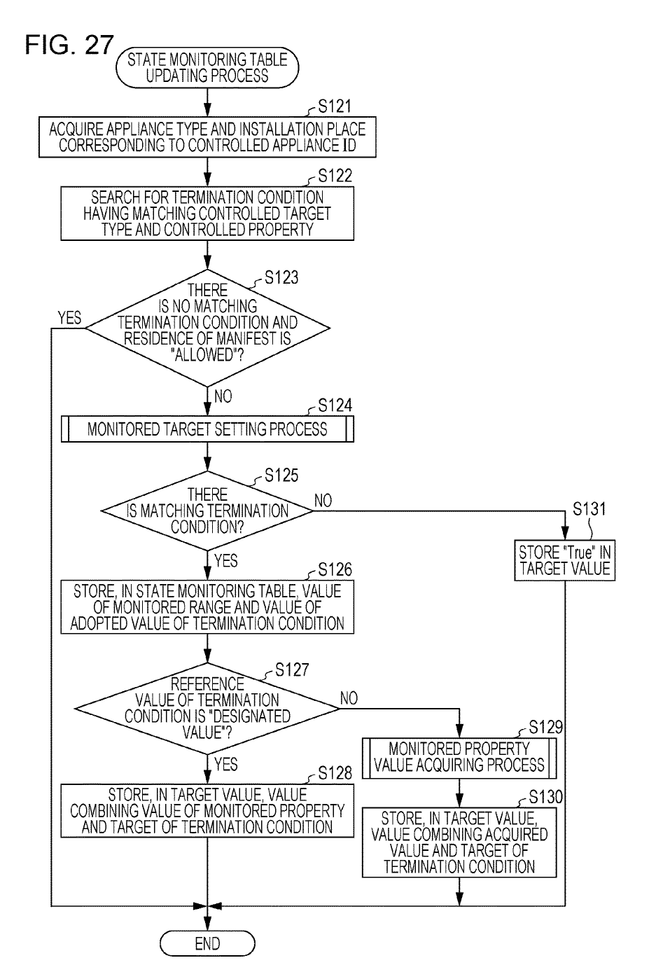

Furthermore, in the present embodiment 2, the flow of the state monitoring table updating process illustrated in FIG. 16 is changed. Details of a state monitoring table updating process in the present embodiment 2 is described below with reference to FIG. 27. FIG. 27 is a flow chart for explaining the state monitoring table updating process in Embodiment 2 of the present disclosure.

In Step S121 of the state monitoring table updating process in the present embodiment 2, an execution determining unit 3021 acquires an appliance type and an installation place that correspond to a controlled appliance ID of which the execution determining unit 3021 has been notified by a service execution unit 301. In order to realize the process in Step S121, a storage unit 203 of the reconciliation device 103 holds a correspondence table like the one illustrated in FIG. 26, as in Embodiment 1. For example, in a case where an air conditioner in a house executes a succeeding service and where the appliance ID of the air conditioner is “AirConditioner1”, the execution determining unit 3021 acquires an appliance type “air conditioner” and an installation place “LivingRoom1” in a row 711 as a result of the process in Step S121.

Next, in Step S122, the execution determining unit 3021 searches the termination condition 521 of the manifest of the service illustrated in FIG. 24 for a termination condition having matching controlled target type and controlled property. For example, in a case where a control request is for changing a controlled property “set temperature value”, a termination condition in a row 512A matches as a result of search of a controlled target type 502A and a controlled property 502B in the termination condition 521 in the process in Step S122.

Next, in Step S123, the execution determining unit 3021 determines whether or not there is no matching termination condition and residence of the manifest is “allowed”. In a case where it is determined that there is no matching termination condition and residence of the manifest is “allowed” (YES in Step S123), the process is finished.

Meanwhile, in a case where it is determined that there is no matching termination condition and residence of the manifest is not “allowed”, in a case where there is a matching termination condition and residence of the manifest is “allowed”, or in a case where it is determined that there is a matching termination condition and residence of the manifest is not “allowed” (NO in Step S123), the execution determining unit 3021 performs a monitored target setting process for setting information on a monitored target in Step S124. Note that the monitored target setting process in Step S124 is similar to that in Embodiment 1, and therefore description thereof is omitted.

When the monitored target setting process is finished, the execution determining unit 3021 determines in Step S125 whether or not there is a termination condition having matching controlled target type and controlled property in the process in Step S122. In a case where it is determined that there is a matching termination condition (YES in Step S125), the execution determining unit 3021 causes a value of the monitored range 502F and a value of the adopted value 502G in a row having matching controlled target type and controlled property in the termination condition 521 to be stored in the monitored range 805 and the adopted value 806 of the state monitoring table 3023, respectively, in Step S126.

Next, in Step S127, the execution determining unit 3021 determines whether or not a reference value 502D in the row having matching controlled target type and controlled property in the termination condition 521 is a “designated value” by referring to the reference value 502D.

In a case where it is determined that the reference value 502D is a “designated value” (YES in Step S127), the execution determining unit 3021 causes a value combining a value of the monitored property 502C designated in the control request and the target 502E of the termination condition 521 to be stored in the target value 803 of the state monitoring table 3023 in Step S128 and then finishes the process.

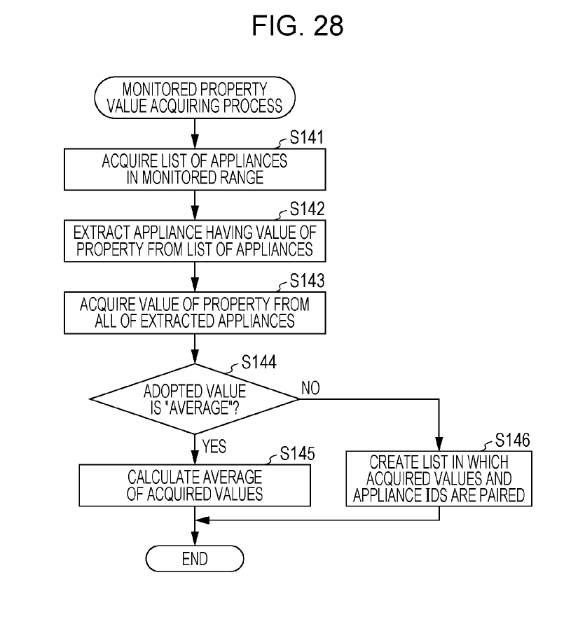

Meanwhile, in a case where it is determined that the reference value 502D is not a “designated value” (NO in Step S127), the execution determining unit 3021 performs a monitored property value acquiring process for acquiring a current value of a monitored property in Step S129. Details of the monitored property value acquiring process in Step S129 are described below. FIG. 28 is a flow chart for explaining the monitored property value acquiring process in Step S129 of FIG. 27.

First, in Step S141 of the monitored property value acquiring process, the execution determining unit 3021 acquires a list of appliances that are present in the monitored range 805 by referring to the monitored range 805 in a row that is currently manipulated in the state monitoring table 3023. In order to realize the process in Step S141, for example, all rows in which a value stored in the installation place 703 of the correspondence table is identical to the value of the monitored range 805 are extracted by searching the correspondence table in FIG. 26.

Next, in Step S142, the execution determining unit 3021 extracts an appliance having the value of the property 802 in the row that is currently manipulated in the state monitoring table 3023 from the acquired list of appliances. The process in Step S142 is realized, for example, by searching a list, such as GetPropertyMap in the ECHONET Lite standard, in which appliances and properties that can be acquired are associated with each other.

Next, in Step S143, the execution determining unit 3021 acquires a value of the property 802 from all of the appliances thus extracted via the appliance control unit 303.

Next, in Step S144, the execution determining unit 3021 determines whether or not the adopted value 806 in the row that is currently manipulated in the state monitoring table 3023 is “AVERAGE”. In a case where it is determined that the adopted value 806 is “AVERAGE” (YES in Step S144), the execution determining unit 3021 calculates, in Step S145, an average of all values acquired in the process in Step S143 and then finishes the process.

Meanwhile, in a case where it is determined that the adopted value 806 is not “AVERAGE”, i.e., in a case where it is determined that the adopted value 806 is “AND” or “OR” (NO in Step S144), the execution determining unit 3021 creates, in Step S146, a list in which all of the values acquired in the process in Step S143 and corresponding appliance IDs are paired and then finishes the process.

See FIG. 27 again. After a value is acquired by the monitored property value acquiring process, the execution determining unit 3021 causes a value combining the acquired value and the target 502E of the termination condition 521 to be stored in the target value 803 of the state monitoring table 3023 in Step S130 and then finishes the process. In a case where the value acquired by the monitored property value acquiring process is a list, various methods can be employed as a method for combining values in the list and the target 502E of the termination condition 521. For example, the execution determining unit 3021 may calculate an average of values in the list and then cause a value combining the calculated average and the target 502E of the termination condition 521 to be stored in the target value 803 of the state monitoring table 3023. Alternatively, the execution determining unit 3021 may select a used value on the basis of appliance IDs of respective pairs in the list and then cause a value combining the selected value and the target 502E of the termination condition 521 to be stored in the target value 803 of the state monitoring table 3023. As described above, the target value 803 can be designated so as to monitor an absolute value by the process 2008 in Step S128 or monitor a relative value by the processes in Step S129 and Step S130.

In a case where it is determined in Step S125 that there is no matching termination condition (NO in Step S125), the execution determining unit 3021 causes a value indicating that a condition is always established to be stored in the target value 803 of the state monitoring table 3023 in Step S131 and then finishes the process. In the process in Step S131, “True” is stored as an example of the value indicating that a condition is always established, as in Embodiment 1. FIG. 25 illustrates an example of a state of the state monitoring table 3023 at the end of the state monitoring table updating process in the present embodiment 2.

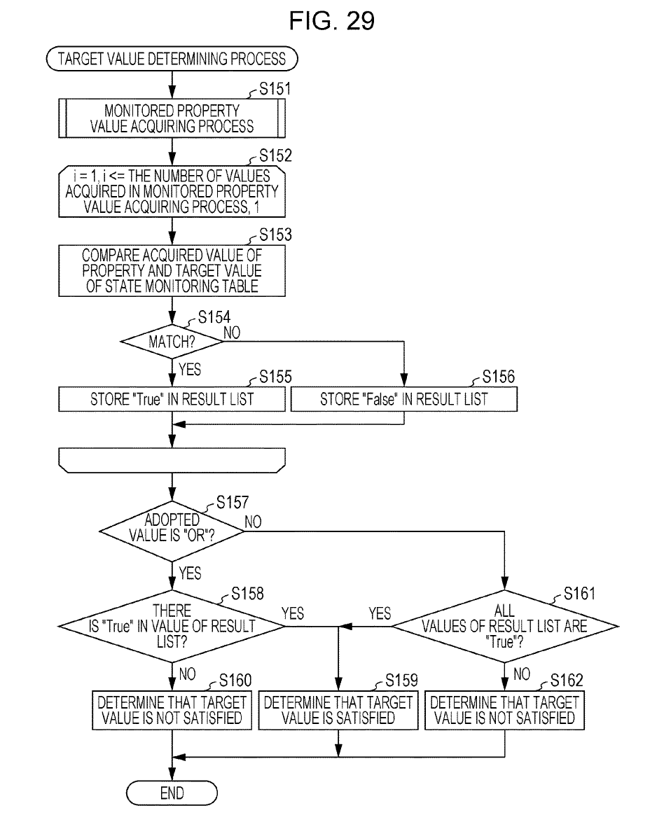

In the present embodiment 2, the flow of the target value determining process illustrated in FIG. 21 is changed. Details of a target value determining process in the present embodiment 2 are described below with reference to FIG. 29. FIG. 29 is a flow chart for explaining the target value determining process in Embodiment 2 of the present disclosure.

First, in Step S151 of the target value determining process, a state monitoring unit 3024 performs a monitored property value acquiring process for acquiring a current value of a monitored property. Note that the monitored property value acquiring process in Step S151 is similar to that in FIG. 28, and therefore description thereof is omitted.

Next, in Step S152, the state monitoring unit 3024 inspects all values acquired in the monitored property value acquiring process.

Next, in Step S153, the state monitoring unit 3024 compares each of the acquired values of a property and a value described in the target value 803 of the state monitoring table 3023.

Next, in Step S154, the state monitoring unit 3024 determines whether or not the acquired value of the property and the value described in the target value 803 of the state monitoring table 3023 match each other. In a case where it is determined that the acquired value of the property and the value described in the target value 803 of the state monitoring table 3023 match each other (YES in Step S154), the state monitoring unit 3024 causes a value indicating that it has been determined that a target value has been satisfied to be stored in a result list in Step S155. For example, the value indicating that it has been determined that a target value has been satisfied is “True”, and the state monitoring unit 3024 causes “True” to be stored in the result list.

Meanwhile, in a case where it is determined that the acquired value of the property and the value described in the target value 803 of the state monitoring table 3023 do not match each other (NO in Step S154), the state monitoring unit 3024 causes a value indicating that it has been determined that a target value has not been satisfied to be stored in the result list in Step S156. For example, the value indicating that it has been determined that a target value has not been satisfied is “False”, and the state monitoring unit 3024 causes “False” to be stored in the result list.

After all of the values acquired in the monitored property value acquiring process are compared, the state monitoring unit 3024 determines in Step S157 whether or not the adopted value 806 of the state monitoring table 3023 is “OR”. In a case where it is determined that the adopted value 806 is “OR” (YES in Step S157), the state monitoring unit 3024 determines, in Step S158, whether or not “True” is included in values of the result list created in the processes in Step S155 and Step S156.

In a case where it is determined that “True” is included in the values of the result list (YES in Step S158), the state monitoring unit 3024 determines in Step S159 that the target value has been satisfied and then finishes the process. Meanwhile, in a case where it is determined that “True” is not included in the values of the result list (NO in Step S158), the state monitoring unit 3024 determines in Step S160 that the target value has not been satisfied and then finishes the process.

Meanwhile, in a case where it is determined in Step S157 that the adopted value 806 is not “OR”, i.e., in a case where it is determined in Step S157 that the adopted value 806 is “AND” or “AVERAGE” (NO in Step S157), the state monitoring unit 3024 determines in Step S161 whether or not all of the values in the result list created in the processes in Step S155 and Step S156 are “True”. In a case where it is determined that all of the values in the result list are “True” (YES in Step S161), the state monitoring unit 3024 determines in Step S159 that the target value has been satisfied and then finishes the process. Meanwhile, in a case where it is determined that not all of the values in the result list are “True” (NO in Step S161), the state monitoring unit 3024 determines in Step S162 that the target value has not been satisfied and then finishes the process.

In the above description, the processes (Steps S151 through S156) for comparing all of the values of the property acquired in the monitored property value acquiring process and the logical operation (Steps S157 through S152) of the results of the comparison are sequentially performed. However, this is an example, and short-circuit evaluation in general logical operation may be performed.

As described above, space estimation information may be information indicative of states of a plurality of appliances. The plurality of appliances may be placed in the same closed space. The state monitoring unit 3024 may determine whether or not each of pieces of space estimation information acquired from the respective plurality of appliances satisfies a predetermined condition, and determine that a state of a space is not a state that should be satisfied by the first service in a case where it is determined that any of the pieces of space estimation information does not satisfy the predetermined condition. Alternatively, the state monitoring unit 3024 may determine whether or not at least one of the pieces of space estimation information acquired from the respective plurality of appliances satisfies a predetermined condition, and determine that a state of a space is not a state that should be satisfied by the first service in a case where it is determined that none of the pieces of space estimation information satisfies the predetermined condition. Alternatively, the state monitoring unit 3024 may determine whether or not an average of values acquired from the respective plurality of appliances satisfies a predetermined condition, and determine that a state of a space is not a state that should be satisfied by the first service in a case where it is determined that the average of the values does not satisfy the predetermined condition.

As described above, in the process for determining a termination condition of appliance control in the present embodiment 2, any number of appliances having a designated monitored property are monitored. This makes it possible to flexibly set a termination condition of appliance control in accordance with states of a plurality of appliances in a house. That is, even in a case where an appliance is newly added or even in a case where a user no longer uses an appliance due to relocation, handover, malfunction, or the like of the appliance, settings of monitored appliances can be dynamically changed in accordance with an environment without forcing the user to perform a complicated operation such as setting monitored appliances again.

In the above description, the adopted value 806 of the state monitoring table 3023 includes three kinds of values “AND”, “OR”, and “AVERAGE”, but can be modified in various ways. For example, the adopted value 806 may be one that requires that a certain number of appliances satisfy a target value. Furthermore, the monitored range 805 and the adopted value 806 in the state monitoring table 3023 may be changed at any timing by a user's operation of an application operating in the operation terminal 101.

Furthermore, a time may be designated in the monitored property 502C of the termination condition 521 as in Embodiment 1. Furthermore, a value of any element that can be acquired from any appliance including the operation terminal 101, the first appliance 104, and the second appliance 105 that are connected to the communication network 102 may be designated in the monitored property 502C. For example, in a case where the second appliance 105 is a mobile terminal, a wearable terminal, or the like carried by a user, positional information of the second appliance 105 may be designated in the monitored property 502C. As a method for acquiring the positional information, various methods such as GPS (Global Positioning System), triangulation using the intensity of radio waves transmitted and received by a wireless transmitter/receiver provided in a house, or autonomous navigation using various sensors such as acceleration, angular velocity, and magnetic sensors mounted in a terminal are applicable. This allows positional information of a user or a terminal carried by the user to be used as a termination condition of appliance control.

Furthermore, the monitored property 502C may be a state of pressing of a specific button displayed on a screen of an application operating in the operation terminal 101. This makes it possible to monitor a user's operation of pressing a button. This is realized, for example, by displaying a button for giving an instruction to terminate appliance control on a screen of an application operating in the operation terminal 101 at a timing at which appliance control succeeds as a result of execution of a service, i.e., at a timing at which the service execution unit 301 notifies the operation terminal 101 of a control result in Step S26 of FIG. 12. When the button is pressed down by the user at any timing, the state monitoring unit 3024 is notified of a change of a state by the operation terminal 101 via the service execution unit 301 and the execution determining unit 3021. This makes it possible to terminate execution of a service at a timing designated by the user.

### Embodiment 3

In Embodiment 1 and Embodiment 2 of the present disclosure, the reconciliation unit 302 of the reconciliation device 103 reconciles control requests or determines whether to or execute a service. However, according to this configuration, in a case where a plurality of reconciliation devices are present in the same network, there is a possibility that a situation where each of the reconciliation devices individually manages different appliances occurs. As a result, inconsistency may occur among occupation states of appliance control managed by the respective reconciliation devices. Meanwhile, according to appliance control of the present embodiment 3, in a case where a plurality of reconciliation devices are present in a network, the plurality of reconciliation devices reconcile control requests in cooperation with one another.

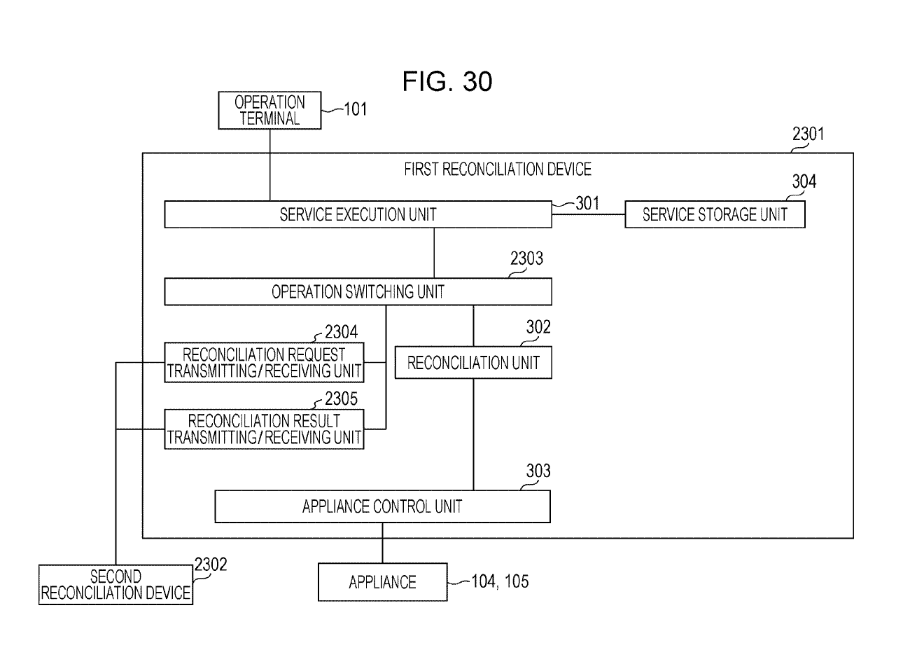

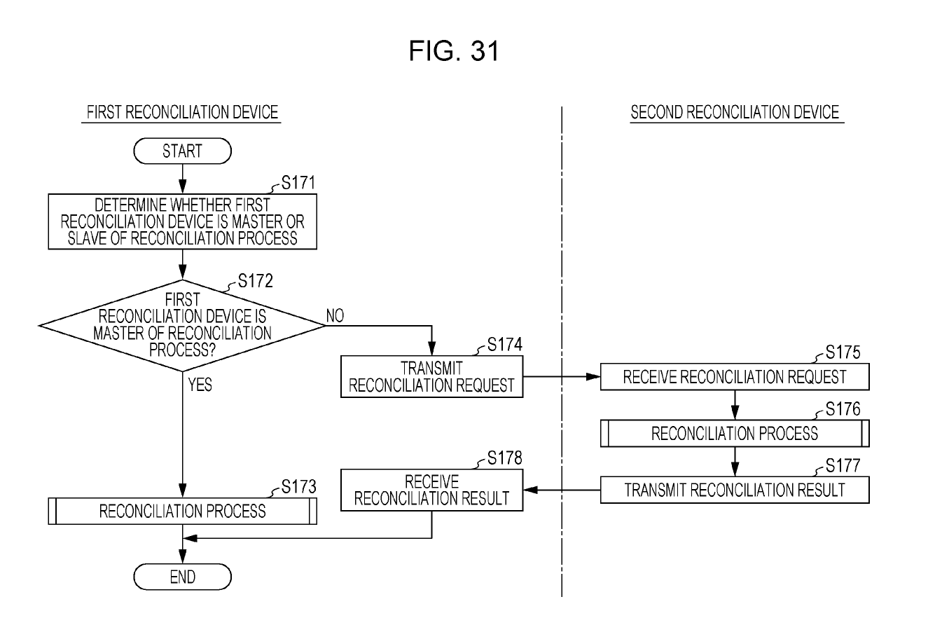

FIG. 30 is a diagram illustrating an example of a detailed configuration of a reconciliation device according to Embodiment 3 of the present disclosure. As illustrated in FIG. 30, in the present embodiment 3, an appliance control system includes a first reconciliation device 2301 and a second reconciliation device 2302. The first reconciliation device 2301 includes a service execution unit 301, a reconciliation unit 302, an appliance control unit 303, and a service storage unit 304, as with the reconciliation devices 103 in Embodiment 1 and Embodiment 2. The first reconciliation device 2301 further includes an operation switching unit 2303, a reconciliation request transmitting/receiving unit 2304, and a reconciliation result transmitting/receiving unit 2305. Constituent elements of the second reconciliation device 2302 are similar to those of the first reconciliation device 2301, and therefore description thereof is omitted.

The operation switching unit 2303 switches between a first operation of performing a reconciliation process for reconciling control requests by itself and a second operation of handing over the reconciliation process to the second reconciliation device 2302 in a case where a plurality of reconciliation units 302 are present in the same network.

The reconciliation request transmitting/receiving unit 2304 transmits a reconciliation request that requests the second reconciliation device 2302 to reconcile control requests and receives a reconciliation request from the second reconciliation device 2302. Note that a detailed operation of the reconciliation request transmitting/receiving unit 2304 will be described later.

The reconciliation result transmitting/receiving unit 2305 receives a reconciliation result of reconciliation of control requests from the second reconciliation device 2302 and transmits a reconciliation result to the second reconciliation device 2302. Note that a detailed operation of the reconciliation result transmitting/receiving unit 2305 will be described later.

Next, a flow of processes of the first reconciliation device 2301 and the second reconciliation device 2302 that are performed in a case where an appliance is caused to execute a service is described with reference to FIG. 31. FIG. 31 is a flow chart for explaining an operation of a reconciliation process performed by the first reconciliation device and the second reconciliation device in Embodiment 3 of the present disclosure. In the following example, an appliance that issues a control request for causing the appliance to execute a service is referred to as the first reconciliation device 2301, and an appliance including the reconciliation unit 302 that is not the first reconciliation device 2301 is referred to as the second reconciliation device 2302.

When an appliance starts execution of a service, first, in Step S171, the operation switching unit 2303 of the first reconciliation device 2301 determines whether the first reconciliation device 2301 is a master or a slave of a reconciliation process in the network. The expression “the first reconciliation device 2301 is a master” means that the first reconciliation device 2301 receives a request for a reconciliation process from all of the other reconciliation devices in the network and performs a reconciliation process in the reconciliation unit 302 of the first reconciliation device 2301. The expression “the first reconciliation device 2301 is a slave” means that the first reconciliation device 2301 transmits a reconciliation request that requests any of the other reconciliation devices in the network to perform a reconciliation process and receives a reconciliation result. Whether or not a reconciliation device is a master or a slave in the network is determined in advance. For example, whether or not the first reconciliation device 2301 and the second reconciliation device 2302 are a master or a slave can be determined in various ways and is, for example, set in advance by a user by using an application operating in the operation terminal 101.

Next, in Step S172, the operation switching unit 2303 determines whether or not the first reconciliation device 2301 is a master of a reconciliation process as a result of the determining process in Step S171. In a case where it is determined that the first reconciliation device 2301 is a master of a reconciliation process (YES in Step S172), the reconciliation unit 302 performs a reconciliation process for reconciling a plurality of control requests in Step S173 and then finishes the process. The reconciliation process in Step S173 is similar to the processes in FIGS. 11 and 12, and therefore description thereof is omitted.

Meanwhile, in a case where it is determined in Step S172 that the first reconciliation device 2301 is not a master of a reconciliation process, i.e., in a case where it is determined in Step S172 that the first reconciliation device 2301 is a slave of a reconciliation process (NO in Step S172), the reconciliation request transmitting/receiving unit 2304 transmits a reconciliation request to the second reconciliation device 2302 in Step S174. The reconciliation request includes at least service IDs of executed services and control requests themselves. Contents of the service IDs and the control requests are similar to those in Embodiment 1, and therefore description thereof is omitted.

Next, in Step S175, the reconciliation request transmitting/receiving unit 2304 of the second reconciliation device 2302 receives the reconciliation request transmitted by the first reconciliation device 2301.

Next, in Step S176, the reconciliation unit 302 performs a reconciliation process for reconciling a plurality of control requests. The reconciliation process in Step S176 is almost similar to the processes in FIGS. 11 and 12 but is different from the processes in FIGS. 11 and 12 in the following two points. First, the reconciliation request transmitting/receiving unit 2304 notifies the service execution unit 301 of the service IDs and the control requests that are included in the reconciliation request received from the first reconciliation device 2301 before execution of the process in Step S11. Second, the processes in Step S25 and Step S26 are not performed, and the execution determining unit 3021 notifies the reconciliation result transmitting/receiving unit 2305 of a reconciliation result.

Next, in Step S177, the reconciliation result transmitting/receiving unit 2305 of the second reconciliation device 2302 transmits the reconciliation result to the first reconciliation device 2301.

Next, in Step S178, the reconciliation result transmitting/receiving unit 2305 of the first reconciliation device 2301 receives the reconciliation result transmitted from the second reconciliation device 2302 and then finishes the process.

Through the aforementioned processes, a plurality of control requests can be properly reconciled even in a case where a plurality of reconciliation devices each including the reconciliation unit 302 are present in the same network.

Note that the appliance control system of the present embodiment 3 includes two reconciliation devices, but the present disclosure is not limited to this in particular. The appliance control system may include three or more reconciliation devices.

A reconciliation method, a reconciliation device, and a recording medium storing a reconciliation program of the present disclosure can set a period in which a first service occupies a first appliance in accordance with an environment in a space that changes by execution of the first service and can reconcile a first control request and a second control request that compete against each other, and are useful as a reconciliation method, a reconciliation device, and a recording medium storing a reconciliation program for reconciling a plurality of control requests that are transmitted to cause an appliance to execute a different plurality of services.

What is claimed is:

1. A control method for a controller connected to a first appliance, the control method comprising:
accepting a first request for causing the first appliance to execute a first service, the first appliance being disposed in a first space;
transmitting a first command to execute the first service to the first appliance;
acquiring first information indicative of an environment state of the first space; and
determining whether or not the environment state satisfies a termination condition of the first service based on a correspondence between the first service and the termination condition of the first service and the first information, wherein
when it is determined that the environment state does not satisfy the termination condition of the first service, a second request for causing the first appliance to execute a second service different from the first service is not accepted, and a second command to execute the second service is not transmitted to the first appliance.

2. The control method according to claim 1, wherein
the first information includes a temperature value, a humidity value, or an illuminance value of the first space.

3. The control method according to claim 1, wherein
when it is determined that the environment state satisfies the termination condition of the first service, the second request is accepted, and the second command to execute the second service is transmitted to the first appliance.

4. The control method according to claim 1, wherein
the first appliance is disposed at a first position in the first space,
the first information indicates the environment state at the first position, and
the first information is acquired from the first appliance.

5. The control method according to claim 1, wherein
the controller is further connected to a second appliance different from the first appliance,
the second appliance is disposed at a second position in the first space,
the first information indicates the environment state at the second position, and
the first information is acquired from the second appliance.

6. The control method according to claim 1, wherein
the first information includes a parameter that is the same as a parameter changed when the first appliance executes the first service.

7. The control method according to claim 1, wherein
the first information is expressed by a parameter that is different from a parameter changed when the first appliance executes the first service.

8. The control method according to claim 1, wherein
the first information includes a numeric value corresponding to the environment state, and
it is determined that the environment state does not satisfy the termination condition of the first service when the numeric value is not within a predetermined range.

9. The control method according to claim 1, wherein
the first information includes a numeric value indicative of an amount of change of the environment state from transmission of the first command to the first appliance to a current time, and
it is determined that the environment state does not satisfy the termination condition of the first service when the amount of change is not within a predetermined range.

10. The control method according to claim 1, wherein
the controller is further connected to a second appliance different from the first appliance,
the first appliance is disposed at a first position in the first space,
the second appliance is disposed at a second position in the first space,
the first information includes second information indicative of a first environment state at the first position and third information indicative of a second environment state at the second position,
the second information is acquired from the first appliance,
the third information is acquired from the second appliance, and
it is determined that the environment state does not satisfy the termination condition of the first service in a case where the first environment state and the second environment state do not satisfy a predetermined condition.

11. The control method according to claim 1, wherein
the controller is further connected to a second appliance different from the first appliance;
the first appliance is disposed at a first position in the first space,
the second appliance is disposed at a second position in the first space,
the first information includes second information indicative of a first environment state at the first position and third information indicative of a second environment state at the second position,
the second information is acquired from the first appliance,
the third information is acquired from the second appliance, and
it is determined that the environment state does not satisfy the termination condition of the first service when at least one of the first environment state and the second environment state does not satisfy a predetermined condition.

12. The control method according to claim 1, wherein
the controller is further connected to a second appliance different from the first appliance,
the first appliance is disposed at a first position in the first space,
the second appliance is disposed at a second position in the first space,
the first information includes second information indicative of a first environment state at the first position and third information indicative of a second environment state at the second position,
the second information is acquired from the first appliance,
the third information is acquired from the second appliance,
the first environment state is a first value,
the second environment state is a second value, and
it is determined that the environment state does not satisfy the termination condition of the first service in a case where an average of the first value and the second value does not satisfy a predetermined condition.

13. The control method according to claim 1, wherein
the first space is a closed space.

14. The control method according to claim 1, wherein
the first information indicates an elapsed period from transmission of the first command to a current time, and
it is determined that the environment state does not satisfy the termination condition of the first service when the elapsed period is not within a predetermined range.

15. The control method according to claim 1, wherein
the first information indicates an elapsed period from a timing at which the first appliance reaches a predetermined state after transmission of the first command to a current time, and
it is determined that the environment state does not satisfy the termination condition of the first service when the elapsed period is not within a predetermined range.

16. The control method according to claim 1, wherein
the controller includes a memory, and
the correspondence is stored in the memory.

17. The control method according to claim 1, wherein
the correspondence is included in the first request.

18. The control method according to claim 1, wherein
the correspondence is input to the controller by a user of the first appliance.

19. A control device connected to a first appliance, the control device comprising:
an input that accepts a first request for causing the first appliance to execute a first service, the first appliance being disposed in a first space;
a transmitter that transmits a first command to execute the first service to the first appliance;
a processor that acquires first information indicative of an environment state of the first space, and
determines whether or not the environment state satisfies a termination condition of the first service based on a correspondence between the first service and the termination condition of the first service and the first information, wherein
when it is determined that the environment state does not satisfy the termination condition of the first service, a second request for causing the first appliance to execute a second service different from the first service is not accepted, and a second command to execute the second service is not transmitted to the first appliance.

20. A recording medium storing a program for causing a processor to execute processes including:
accepting a first request for causing the first appliance to execute a first service, the first appliance being disposed in a first space;
transmitting a first command to execute the first service to the first appliance;
acquiring first information indicative of an environment state of the first space; and
determining whether or not the environment state satisfies a termination condition of the first service based on a correspondence between the first service and the termination condition of the first service and the first information, wherein
when it is determined that the environment state does not satisfy the termination condition of the first service, a second request for causing the first appliance to execute a second service different from the first service is not accepted, and a second command to execute the second service is not transmitted to the first appliance.
